(19) United States
(12) Patent Application Publication
(10) Pub. No.: US 2005/0260514 A1
(43) Pub. Date: Nov. 24, 2005

(54) Charge controlling agent containing polyhydroxyalkanoate containing unit containing carboxyl group on side chain in molecule, toner binder and toner, and image formation method and image forming apparatus using toner

(75) Inventors: Chieko Mihara, Isehara-shi (JP); Tetsuya Yano, Atsugi-shi (JP); Shinya Kozaki, Setagaya-ku (JP); Tstutomu Honma, Atsugi-shi (JP); Takashi Kenmoku, Fujisawa-shi (JP); Tatsuki Fukui, Yokohama-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/532,137

(22) PCT Filed: Oct. 23, 2003
(86) PCT No.: PCT/JP03/13534

§ 371 Date: Apr. 20, 2005

(30) Foreign Application Priority Data
Oct. 24, 2002 (JP) NO. 2002-310249
Oct. 16, 2003 (JP) NO. 2003-356962

(51) Int. Cl. G03G 9/097

(52) U.S. Cl. 430/108.4; 430/124; 528/272

(57) ABSTRACT

The present invention provides a negataively chargeable charge controlling agent to control a charged state of a powder or granular material such as toner for electrophotography, where the agent comprises a polyhydroxyalkanoate having at least one kind of 3-hydroxy-ω-carboxyalkanoic acid unit represented by the chemical formula (1): 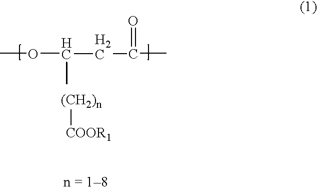
wherein n is an integer selected from 1 to 8; R₁ is an H, Na or K atom, or 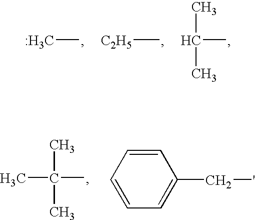
and when more than one unit exists, n and R₁ is the same or different between the units. The charge controlling agent is excellent in electrophtographic properties and propitious to environment because of the biodegradability of the polyhydroxyalkanoate. 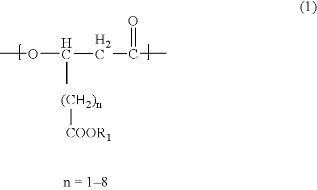
wherein n is an integer selected from the range shown in the same chemical formula; R₁ is an H atom, Na atom, K atom, or 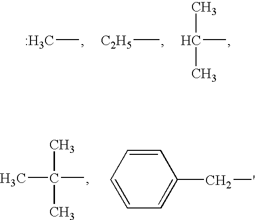
and when more than one unit exists, n and R₁ may differ from unit to unit.

### TECHNICAL FEILD

The present invention relates to a charge controlling agent for use in electrophotography, electrostatic recording, magnetic recording and the like, a toner binder, an electrostatic latent image developing toner, an image formation method using the toner, and an image forming apparatus for use therein. In particular, the present invention relates to a charge controlling agent, a toner binder, a toner for developing electrostatic charge images used in electrophotography, electrostatic recording, and electrostatic printing with a copier, printer, and fax, in which a toner image is formed on an electrostatic latent image carrier (hereinafter simply referred to as image carrier) and then the toner image is transferred onto an object transfer material to form an image, and an image forming method and an image forming apparatus using the toner. More particularly, the present invention relates to a negative charge controlling agent safer for human bodies/environments, a toner binder and a toner for developing electrostatic charge images using the negative charge controlling agent, and an image forming method and an image forming apparatus for the method using the toner.

### BACKGROUND ART

So far, many methods have been known for electrophotography, and those methods are generally carried out in such a manner that an electric latent image is formed on an image carrier (photosensitive member) by a variety of means using a photoconductive substance, the latent image is then developed with a toner to form a visible image, and the toner image is transferred onto an object transfer material such as a paper as necessary, followed by fixing the toner image on the object transfer material by heat and/or pressure or the like to obtain a copy. For the method for visualizing the electric latent image, a cascade development method, a magnetic brush development method, a pressurizing development method and the like are known. Further, a method using a magnetic toner and a rotary development sleeve with a magnetic pole placed at the center thereof, where the magnetic toner is caused to fly from the development sleeve onto the photosensitive member by a magnetic field is also used.

Development systems for use in development of an electrostatic latent image include a two-component development system using a two-component type developer constituted by a toner and a carrier, and a one-component development system using a one-component type developer constituted only by a toner and using no carrier.

Here, the colored fine particle generally called as a toner has a binder resin and a coloring material as essential components, and in addition thereto, magnetic powders and the like if necessary. For the method for imparting an electric charge to the toner, the electrifiability (chargeability) of the binder resin itself may be used without using a charge controlling agent, but by this method, charge stability with time and humidity resistance are compromised, thus making it impossible to obtain high quality images. Therefore, the charge controlling agent is usually added for the purpose of maintaining and controlling the charge of the toner.

Charge controlling agents well known in the art today include, for example, azo dye metal complexes, aromatic dicarboxylic acid-metal complexes and salicylic acid derivative-metal complexes as negative friction charging agents. In addition, as positive friction charging agents, nigrosine-based dyes, triphenylmethane-based dyes, various types of quaternary ammonium salts and organic tin compounds such as dibutyl tin oxide are known, but toners containing these substances as the charge controlling agent do not necessarily fully satisfy quality characteristics required for the toner such as the electrifiability and stability with time depending on their compositions.

For example, a toner containing an azo dye metal complex known as a negative charge controlling agent has an acceptable charge level, but may have reduced dispersibility depending on the type of binder resin to be combined because the azo dye metal complex is a low-molecular crystal. In this case, the negative charge controlling agent is not uniformly distributed in the binder resin, the charge level distribution of the obtained toner is significantly broad, and the obtained image has a low gray-level, resulting in a poor image formation capability. In addition, the azo dye metal complex has a unique color tone, and is thus presently used only for toners having limited colors around black, and if the azo dye metal complex is used as a color toner, it is a serious problem that it lacks clarity required for a coloring agent to obtain an image to which high level color tone is required.

In addition, examples of almost colorless negative charge controlling agents include aromatic dicarboxylic-acid metal complexes, but they may be disadvantageous due to the fact that they are not perfectly colorless, and that they have low dispersibility peculiar to low-molecular-weight crystals.

On the other hand, nigrosine based dyes and triphenylmethane based dyes are presently used only for toners having limited colors around black because they are colored themselves, and may be poor in time stability of toners in continuous copying. In addition, conventional quaternary ammonium salts may give insufficient humidity resistance when formed into toners, and in this case, the stability with time may be so poor that high quality images are not provided when they are repeatedly used.

In addition, in recent years, attention has been given worldwide to reduction of wastes and improvement of safety of wastes in terms of environmental protection. This problem applies to the field of electrophotography as well. That is, as imaging apparatuses have become widely used, the amounts of wastes of printed papers, discarded toners and copying papers have increased year by year, and safety of such wastes is important from a viewpoint of protection of global environment.

In the light of these problems, polymer charge controlling agents have been studied. Examples are the compounds disclosed in U.S. Pat. Nos. 4,480,021, 4,442,189 and 4,925,765, Japanese Patent Application Laid-Open Nos. 60-108861, 61-3149, 63-38958, 63-88564. Further, as polymer charge controlling agents that allow toners to exhibit negatively charged characteristics, copolymers of styrene and/or α-methylstyrene with alkyl(meth)acrylate ester or alkyl(meth)acrylate amide having a sulfonic acid group (Japanese Patent Application Laid-Open Nos. 7-72658 and 8-179564, Japanese Patent Nos. 2114410, 2623684 and 2807795) are often used. These materials offer the advantage of being colorless; however, to obtain an intended amount of charge, a large amount of the materials needs to be added.

As described above, these compounds do not offer adequate performance as charge controlling agents, and problems of the amount of charge, charge build-up characteristics, stability over time and environment stability arise with them. Further, taking into consideration not only the functions of charge controlling agents, but also their effect on the human body as well as the environment, charge controlling agents are strongly wanted which can be produced using safer compounds by safer and milder synthesis process with a reduced amount of organic solvent.

Resins that can be decomposed with time by the action of microorganisms and the like, namely biodegradable resins are under development in view of environmental protection, and many types of microorganisms have been reported to produce biodegradable resins having a polyester structure (polyhydroxyalkanoate: hereinafter abbreviated as PHA) and accumulate the resin in the cell. It is known that such PHA may have various compositions and structures depending on the type of microorganism to be used for the production of the PHA, the culture medium composition and the culture conditions, and hitherto studies have been conducted mainly on control of the composition and structure of PHA to be produced in terms of improvements of properties of PHA, having proven performance particularly in the field of medical materials. Also, in the field of agriculture, the biodegradable resin is used in mulch films, horticulture materials, slow-releasable agricultural chemicals, fertilizers and the like. Also, in the leisure industry, the biodegradable resin is used in fishing lines, fishing tackles, golf requites and the like.

However, considering a wide range of application as a plastic, the above described PHAs are not fully usable in terms of their properties at present. For further expansion of the range of application of PHA, it is important to conduct a wide range of studies to improve its properties, and for this purpose, research and development of PHA having monomer units of a variety of structures is prerequisite. On the other hand, PHA with a substituent group introduced to the side chain is expected to be developed as a “functional polymer” with very useful functions and properties originating from the introduced substituent group by selecting the substituent to be introduced according to desired characteristics and the like. That is, it is also an important challenge to conduct of development and search of excellent PHA having both such functionality and biodegradability.

Application of a biodegradable resin to a binder resin particularly in production of toners is proposed in the field of electrophotography as well. U.S. Pat. No. 5,004,664 discloses a toner having as its composition a biodegradable resin, particularly polyhydroxy butyric acid and polyhydroxy valeric acid, a copolymer thereof or a blend thereof. In addition, Japanese Patent Application Laid-Open No. 6-289644 discloses an electrophotographic toner particularly for heat roll fixation characterized in that at least the binder resin contains a plant based wax and a biodegradable resin, and the plant based wax is added in the binder in an amount of 5 to 50% by weight.

In addition, Japanese Patent Application Laid-Open No. 7-120975 discloses an electrophotographic toner characterized by containing a lactic acid based resin as a binder resin. In addition, Japanese Patent Application Laid-Open No. 9-274335 discloses an electrostatic latent image developing toner characterized by containing a polyester resin obtained by dehydrating polycondensation of a composition containing lactic acid and tri- or higher functional oxycarboxylic acid and a coloring agent.

In addition, Japanese Patent Application Laid-Open No. 8-262796 discloses an electrophotographic toner containing a binder resin and a coloring agent, characterized in that the binder resin is composed of a biodegradable resin, and the coloring agent is composed of non-water soluble pigments. In addition, Japanese Patent Application Laid-Open No. 9-281746 discloses an electrostatic latent image developing toner characterized by containing a coloring agent and an urethane-modified polyester resin obtained by cross-linking polylactic acid with a tri- or higher functional polyvalent isocyanate.

Any one of the above described electrophotographic toners contains a biodegradable resin as binder resin, and is regarded to be effective in preservation of environments and the like.

However, reports on using a biodegradable resin in the charge controlling agent have not been known, and there is a room of further improvement for environment preservation.

Moreover, as another technique relating to the present invention, there is a technique relating to obtain carboxylic acid by oxidation of a carbon-carbon double bond with an oxidizing agent (Japanese Patent Application Laid-Open No. 59-190945, J. Chem. Soc., Perkin. Trans. 1, 806 (1973), Org. Synth., 4, 698 (1963), J. Org. Chem., 46, 19 (1981), J. Am. Chem. Soc., 81, 4273 (1959), Macromolecular chemistry, 4, 289-293 (2001)).

### DISCLOSURE OF THE INVENTION

For solving the above described problems, the present invention provides a negatively chargeable charge controlling agent being more contributable to preservation of the environment, and having high performance (high charge level, quick build-up of charge, excellent stability with time, and high environmental stability) and improved dispersibility. The present invention also provides a toner binder containing the charge controlling agent, an electrostatic latent image developing toner containing the charge controlling agent, and an image formation method and an image forming apparatus using the electrostatic latent image developing toner.

In order to develop a charge controlling agent contributable to preservation of environments and the like and having high performance, the inventors studied strenuously and achieved the present invention. That is, the present invention is summarized as follows.

[1] In a charge control agent for controlling a charge of powder or granules, wherein the charge control agent comprises a polyhydroxyalkanoate having at least one kind of 3-hydroxy-ω-carboxyalkanoic acid unit represented by the chemical formula (1): 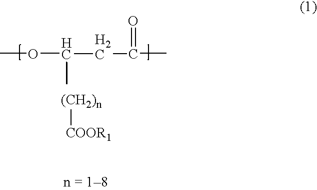
wherein n is an integer selected from the range shown in the same chemical formula; R₁ is an H, Na or K atom, or 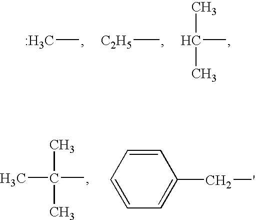
and when more than one unit exists, n and R₁ may differ from unit to unit.
[2] A toner binder used for a toner for developing electrostatic charge images, characterized by comprising the charge controlling agent according to above [1].
[3] A toner for developing electrostatic charge images, characterized by comprising at least a binder resin, a colorant and the charge control agent according to above [1].
[4] An image forming method, comprising at least a charging step of charging an electrostatic latent image carrier by applying voltage to a charging member from the outside; an electrostatic charge image forming step of forming an electrostatic charge image on the charged electrostatic latent image carrier; a developing step of developing the electrostatic charge image with a toner for developing electrostatic charge images to form a toner image on the electrostatic latent image carrier; a transferring step of transferring the toner image on the electrostatic latent image carrier to a recording medium; and a fixing step of fixing the toner image on the recording medium by heat, characterized in that it uses at least a binder resin, a colorant and the charge control agent according to above [1].
[5] An image forming apparatus, comprising at least charging means of charging an electrostatic latent image carrier by applying voltage to a charging member from the outside; electrostatic charge image forming means of forming an electrostatic charge image on the charged electrostatic latent image carrier; developing means of developing the electrostatic charge image with a toner for developing electrostatic charge images to form a toner image on the electrostatic latent image carrier; transferring means of transferring the toner image on the electrostatic latent image carrier to a recording medium; and fixing means of fixing the toner image on the recording medium by heat, characterized in that it uses at least a binder resin, a colorant and the charge control agent according to [1].
[6] A charge controlling method, characterized by comprising the steps of preparing the charge controlling agent according to [1]; and controlling the charged state of a toner using the charge controlling agent.

The present invention provides a charge controlling agent using a polyhydroxyalkanoate copolymer of a monomer unit having a protected or unprotected carboxyl group at the end of the side chain and hydroxyalkanoate units having a substituent group other than straight chain alkyl groups introduced in the side chain, such as a phenyl structure, thienyl structure or cyclohexyl structure (“unusual PHA”).

In addition, according to the present invention, one or more types of polyhydroxyalkanoate represented by the chemical formula (1) is added to a toner composition as a charge controlling agent having excellent electrification characteristics, improved dispersibility and spent characteristics, to provide a toner for developing electrostatic latent images, causing no image fogging, having excellent transfer properties in an image forming apparatus and high applicability to an electrophotographic process. In addition, the charge controlling agent for use in the present invention is characterized in that because it is colorless or only weakly colored, any colorant can be selected according to the color required for the color toner, and original colors possessed by dyes and pigments are not impaired. In addition, the toner for developing electrostatic images has a very high level of safety, and is biodegradable, and therefore it can be disposed without burning treatment, thus bringing about a significant effect in industry for preservation of environments, such as prevention of air pollution and global warming.

### BRIEF DESCRIPTION OF THE DRAWINGS

FIG. 1 is a schematic explanatory view of an image forming apparatus used in Examples 50 to 76 and Comparative Examples 7 to 12;

FIG. 2 is a sectional view of a principal part of a development apparatus for a two-component developer used in Examples 50 to 76 and Comparative Examples 7 to 12;

FIG. 3 is a schematic explanatory view of a development apparatus having a reuse mechanism of a toner used in Examples 77 to 91 and Comparative Examples 13 to 15;

FIG. 4 is a sectional view of a principal part of a development apparatus for a one-component developer used in Examples 77 to 91 and Comparative Examples 13 to 15;

FIG. 5 is an exploded perspective view of a principal part of a fixation apparatus used in the Example of the present invention;

FIG. 6 is an enlarged sectional view of a principal part showing a film state of the fixation apparatus used in the Example of the present invention at the time when it is not driven; and

FIG. 7 is a schematic view showing a blow-off charge level measuring apparatus for measuring the charge level of the toner.

### BEST MODE FOR CARRYING OUT THE INVENTION

The present invention will be described further in detail showing preferred embodiments. As a result of intensive study for achieving the above object, the inventors have found that the above polyhydroxyalkanoate has excellent characteristics as a charge controlling agent, and has a high level of safety for human bodies and environments, and that a significant effect is exhibited when a toner for developing electrostatic latent images (hereinafter referred to as “toner”) contains the charge controlling agent and the toner is used in an image forming apparatus having a certain development system, resulting in completion of the present invention.

That is, the present invention is a charge controlling agent containing the above polyhydroxyalkanoate, and further a toner containing the charge controlling agent. The present invention is further an image forming method comprising the steps of: charging an electrostatic latent image carrier by applying a voltage to a charging member from the outside; forming a toner image on the electrostatic latent image carrier; transferring the toner image on the electrostatic latent image carrier to a recording medium via or not via an intermediate transfer medium; and fixing the toner image on the recording medium by heat. The present invention is also an image forming apparatus comprising means corresponding to respective steps of the above method, namely charging means, developing means, transferring means and heat-fixing means.

Polyhydroxyalkanoate for use in the present invention has a basic skeleton as a biodegradable resin. It can be used for producing various kinds of products by melt-processing and the like as with the conventional plastics, and also has a remarkable characteristic such that it is decomposed by microorganism to be involved in the material cycle in the natural world unlike synthetic polymers derived from oil. Therefore, it is an effective material in a sense that it can be disposed without burning process and thus contributes to prevention of air pollution and global warming as a plastic enabling preservation of environments.

Polyhydroxyalkanoate suitable as a charge controlling agent for use in the toner of the present invention will be specifically described.

Polyhydroxyalkanoate for use in the present invention is a polyester resin containing 3-hydroxyalkanoate as a monomer unit, which has at least one type of 3-hydroxy-ω-carboxyalkanoic acid units represented by the chemical formula (1) 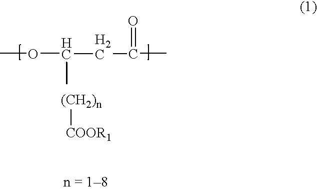
wherein n is an integer selected from the range shown in the same chemical formula; R₁ is an H atom, Na atom, K atom, or a group expressed by one of the following formulas: 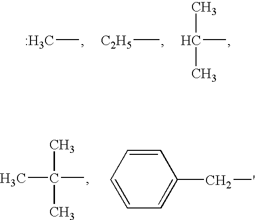
and when more than one unit exists, n and R₁ may differ from unit to unit.

Furthermore, the polyhydroxyalkanoate may contain, besides the 3-hydroxy-ω-carboxyalkanoic acid unit represented by the chemical formula (1), one or both of 3-hydroxy-ω-alkanoic acid units represented by the following chemical formulas (6) and (7) respectively: 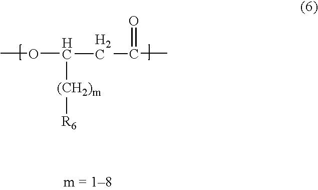
wherein m is an integer selected from the range shown in the same chemical formula; R₆ comprises a residue having either a phenyl structure or a thienyl structure; and when more than one unit exists, m and R₆ may differ from unit to unit; 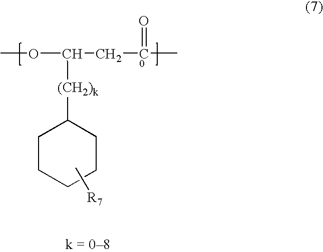
wherein R₇ represents a substitute in the cyclohexyl group and is an H atom, a CN group, an NO₂ group, a halogen atom, a CH₃ group, a C₂H₅ group, a C₃H₇ group, a CF₃ group, C₂F₅ group or a C₃F₇ group; and k is an integer selected from the range shown in the same chemical formula, and when more than one unit exists, R₇ and k may differ from unit to unit.

Here, when polyhydroxyalkanoate is produced by a microorganism, the polyhydroxyalkanoate is an isotactic polymer composed only of R form, but it is not particularly limited to the isotactic polymer and an atactic polymer can be also used as long as the object of the present invention can be achieved in terms of both properties and functions. Also, the PHA can be obtained by a chemical synthesis using ring opening polymerization of a lactone compound or the like.

Examples of methods for producing polyhydroxyalkanoate for use in the present invention will be described below. The polyhydroxyalkanoate represented by the chemical formula (1) of the present invention can be produced by oxidizing the double bonding portion of polyhydroxyalkanoate containing a 3-hydroxy-ω-alkanoic acid unit represented by the chemical formula (19), a starting material. 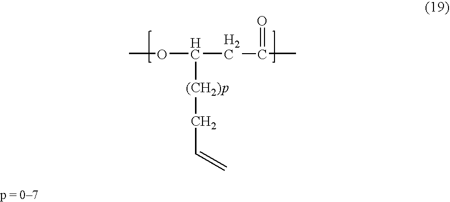
wherein p is an integer selected from the range shown in the same chemical formula, and when more than one unit exists, P may differ from unit to unit.

Examples of known methods of oxidizing and cleaving a carbon-carbon double bond into carboxylic acid using an oxidizing agent are: a method using permanganate (J. Chem. Soc., Perkin. Trans. 1, 806 (1973)); a method using bichromate (Org. Synth., 4, 698 (1963)); a method using periodate (J. Org. Chem., 46, 19(1981)); a method using a nitrate (Japanese Patent Application Laid-Open No. 59-190945); and a method using ozone (J. Am. Chem. Soc., 81, 4273 (1959)). Further, as to polyhydroxyalkanoates, a method is reported in Macromolecular Chemistry, 4, 289-293 (2001), in which the carbon-carbon double bond at the end of polyhydroxyalkaniate side chain is oxidized under acid conditions using potassium permanganate, as an oxidizing agent, to obtain carboxylic acid. In this invention, the same method can be used.

Preferred oxidizing agents used in this invention are, not limited to, permanganates. Of permanganates, potassium permanganate is generally used as an oxidizing agent. The amount of permanganate used should be usually 1 mol equivalent or more per mol of unit represented by the chemical formula (19) and preferably 2 to 10 mol equivalent, since oxidation and cleavage reaction proceeds stoichiometrically.

To make a reaction system acidic, various inorganic acids, such as sulfuric acid, hydrochloric acid, acetic acid and nitric acid, and organic acids are usually used. However, when using an acid such as sulfuric acid, nitric acid or hydrochloric acid, the ester bond of the polyhydroxyalkaniate backbone chain might be broken, causing decrease in molecular weight. Accordingly, acetic acid is preferably used. The amount of acid used is usually in the range of 0.2 to 2000 mol equivalent per mol of unit represented by the chemical formula (19) and preferably in the range of 0.4 to 1000 mol equivalent. The amount less than 0.2 mol equivalent gives the carboxyl acid in a low yield, whereas the amount more than 2000 mol equivalent gives the acid degradation products as by-product. Therefore neither case are preferable.

In order to accelerate the reaction, crown ether can also be used. In this case, crown ether and permanganate form a complex to increase the reactivity. As the crown ether, dibenzo-18-crown-6-ether, dicyclo-18-crown-6-ether or 18-crown-6-ether is generally used. The amount of crown ether used is usually in the range of 0.005 to 2.0 mol equivalent per mol of permanganate and preferably in the range of 0.01 to 1.5 mol equivalent.

As a solvent used in the oxidation reaction of this invention, any solvents can be used as long as they are inactive in the oxidation reaction. For example, water; acetone; ethers such as tetrahydrofuran and dioxane; aromatic hydrocarbons such as benzene, toluene and xylene; aliphatic hydrocarbons such as hexane and heptane; and hydrocarbon halides such as methyl cloride, dicloromethane and chloroform can be used. Of these solvents, hydrocarbon halides, such as methyl chloride, dichloromethane and chloroform, and acetone are preferable, taking into consideration the solubility of polyhydroxyalkanoates.

In the above described oxidation reaction, a polyhydroxyalkanoate copolymer including a unit represented by the chemical formula (19), a permanganate and an acid may be introduced into a solvent at a time from the beginning and reacted together, or they may be separately added to the reaction system continuously or intermittently to be reacted. Or, a permanganate alone is dissolved or suspended in a solvent, followed by continuous or intermittent addition of a polyhydroxyalkanoate and an acid to the reaction system, or first a polyhydroxyalkanoate alone is dissolved or suspended in a solvent, followed by continuous or intermittent addition of a permanganate and an acid to the reaction system. Alternatively, first a polyhydroxyalkanoate and an acid are introduced into a solvent and then a permanganate is added to the reaction system continuously or intermittently to be reacted, or first permanganate and an acid are introduced into a solvent and then polyhydroxyalkanoate is added to the reaction system continuously or intermittently, or first a polyhydroxyalkanoate and a permanganate are introduced into a solvent and then an acid is added to the reaction system continuously and intermittently to be reacted.

The reaction temperature should be usually −40 to 40° C. and preferably −10 to 30° C. The reaction time should be usually 2 to 48 hours, though it depends on the stoichiometric ratio of the ω-alkenoic acid unit represented by the chemical formula (19) to the permanganate and the reaction temperature.

When using a polyhydroxyalkanoate that includes a 3-hydroxy-ω-substituted alkanoic acid unit represented by the chemical formula (6) or a 3-hydroxy-ω-cyclohexyl alkanoic acid unit represented by the chemical formula (7), besides a 3-hydroxy-ω-alkenoic acid unit represented by the chemical formula (19), the reaction can be conducted under the same conditions.

As described above, polyhydroxyalkanoate containing a unit represented by the chemical formula (1), which is an object to be obtained in the present invention, is produced from polyhydroxyalkanoate containing a 3-hydroxy-ω-alkenoic unit having a carbon-carbon double bond at the end of the side chain, represented by the chemical formula (19), which is used as a starting material.

Polyhydroxyalkanoate containing a unit expressed by the Chemical Formula (19), which is used as a starting material in the present invention may be produced by, but not specifically limited to, by a microbial production process, by a bioengineered plant crop system or by chemical polymerization. Preferably, the method of production by a microbial production process is used.

Production methods where polyhydroxyalkanoate containing a 3-hydroxy-ω-alkenoic unit represented by the chemical formula (19) is used as a starting material in the present invention will be described.

The above polyhydroxyalkanoate as a starting material is produced by culturing a production microorganism in a culture medium containing ω-alkenoic represented by the chemical formula (20): 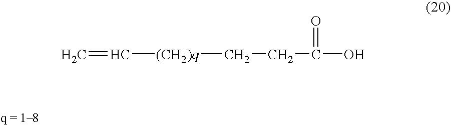
wherein q is an integer selected from the range shown in the chemical formula.

The microorgansm for use in producing polyhydroxyalkanoate containing a unit represented by the chemical formula (19) as a starting material in the present invention may be any microorganism as long as it is a microorganism having a PHA production capability, namely, a microorganism capable of producing a PHA-type polyester containing a 3-hydroxy-ω-alkenoic unit expressed by General Formula (19) by culturing the microorganism in a culture medium containing ω-alkenoic acid represented by the chemical formula (20). One example of suitable usable microorganism having a PHA production capability may be a microorganism belonging to genus Pseudomonas.

More specifically, among microorganisms belonging to Pseudomonas, more preferable species as the microorganism for use in the production method of the present invention may include Pseudomonas cichorii, Pseudomonas putida, Pseudomonas fluorecense, Pseudomonas oleovolans, Pseudomonas aeruginosa, Pseudomonas stutzeri and Pseudomonas jessenii.

Further, a more suitable strain includes, for example, Pseudomonas cichorii YN2 (FERM BP-7375), Pseudomonas cichorii H45 (FERM BP-7374), Pseudomonas jessenii P161 (FERM BP-7376) and Pseudomonas putida P91 (FERM BP-7373). These four types of strains are deposited on Nov. 20, 2000 at International Patent Organism Depositary, National Institute of Bioscience and Human-Technology, Agency of Industry Science and Technology (independent administrative corporation), Tsukuba Central 6, 1-1, Higashi 1-chome, Tsukuba-shi, Ibaraki-ken 305-8566, Japan, and described in Japanese Patent Application Laid-Open No. 2002-80751.

These microorganisms are capable of producing polyhydroxyalkanoat containing a corresponding ω-substituted-3-hydroxy-alkanoic acid as a monomer unit using as a raw material a ω-substituted-straight chain alkanoic acid substituted at the chain terminal with a six-membered ring atom group such as a substituted or unsubstituted phenyl group, a substituted or unsubstituted phenoxy group and a substituted or unsubstituted cyclohexyl group, or a ω-substituted-straight chain alkanoic acid substituted at the chain terminal with a five-membered ring atom group such as a thienyl group.

In the production method of the present invention, any culture medium may be used in the process of culturing a microorganism as long as it is an inorganic salt culture medium containing a phosphate and a nitrogen source such as an ammonium salt or nitrate. In the process of producing PHA in the microorganism, the productivity of PHA may be improved by adjusting the concentration of the nitrogen source.

In addition, nutrients such as an yeast extract, polypeptone and meat extract can be added to the culture medium as a substrate for promoting the propagation of the microorganism. That is, peptides may be added as an energy source and a carbon source in the form of nutrients such as an yeast extract, polypeptone and a meat extract.

Alternatively, the culture medium may contain saccharides, for example, aldoses such as glyceroaldehyde, erythrose, arabinose, xylose, glucose, galactose, mannose and fructose, alditols such as glycerol, erythritol and xylitol, aldonic acids such as gluconic acid, uronic acids such as glucuronic acid and galacturonic acid, and disaccharides such as maltose, sucrose and lactose as an energy source and carbon source consumed for propagation of the microorganism.

Instead of the above described saccharides, organic acids or salts thereof, more specifically organic acids involved in the TCA cycle and organic acids derived from the TCA cycle by a biochemical reaction of a few steps, or water soluble salts thereof may be used. As the organic acid or salt thereof, hydroxycarboxylic acids and oxocarboxylic acids such as pyruvic acid, oxalacetic acid, citric acid, isocitric acid, ketoglutaric acid, succinic acid, fumaric acid, malic acid and lactic acid or water soluble salts thereof can be used. Alternatively, amino acids or salts thereof, for example amino acids such as asparatic acid and glutamic acid or salts thereof can be used. When the organic acid or salt thereof is added, it is more preferable that one or more types are selected from a group consisting of pyruvic acid, oxalacetic acid, citric acid, isocitric acid, ketoglutaric acid, succinic acid, fumaric acid, malic acid, lactic acid and salts thereof, and added to the culture medium and dissolved therein. Alternatively, when the amino acid or salt thereof is added, it is more preferable that one or more types are selected from a group consisting of asparaginic acid, glutamic acid and salts thereof, and added to the culture medium and dissolved therein. At this time, as required, all or part thereof can be added in the form of a water soluble salt to be dissolved uniformly without affecting the pH of the culture medium.

It is desirable that the concentration of the above coexisting substrate added to the culture medium as a carbon source for growth of the microorganism and energy source for production of polyhydroxyalkanoate is usually selected so that it is in the range of from 0.1 to 5% (w/v), more preferably 0.2 to 2% (w/v) per culture medium. That is, for peptides, yeast extracts, organic acids or salts thereof, amino acids or salts thereof, and saccharides, which are used as the above coexisting substrates, one or more types thereof may be added, and, it is desirable that the total concentration of these added substrates is with in the above described range of total concentrations.

It is desirable that the content of the substrate for production of desired polyhydroxyalkanoate, namely ω-alkenoic acid expressed by general formula (20) is selected so that it is in the range of from 0.01 to 1% (w/v), more preferably 0.02 to 0.2% (w/v) per cultural medium.

Any temperature at which microorganism strains to be used can suitably be propagated may be selected as a culture temperature, and an appropriate temperature is usually in the range of from about 15 to 37° C., more preferably from about 20 to 30° C.

Any culture method such as liquid culture and solid culture may be used for the culture as long as it allows propagation of microorganism and production of PHA. In addition, any type of culture method such as batch culture, fed-batch culture, semi-continuous culture and continuous culture may be used. Forms of liquid batch culture include a method of supplying oxygen by shaking the microorganism in a shaking flask, and a method of supplying oxygen by aeration-agitation using a jar fermenter.

For the method of making the microorganism produce and accumulate PHA, a two-step culture method in which the microorganism is cultured by two steps may be adopted other than the one-step culture method in which the microorganism is cultured in an inorganic salt culture medium containing a phosphate and a nitrogen source such as an ammonium salt or a nitrate with the substrate added therein in a predetermined concentration as described above. In this two-step culture method, the microorganism is once propagated sufficiently in the inorganic salt culture medium containing a phosphate and a nitrogen source such as an ammonium salt or a nitrate with a substrate added therein in a predetermined concentration as a primary culture, and thereafter cells obtained by the primary culture are transferred to a culture medium containing the substrate in a predetermined concentration where the amount of nitrogen source such as ammonium chloride is limited, and are further cultured as a secondary culture, thereby making the microorganism produce and accumulate PHA. Use of this two-step culture method may improve the productivity of desired PHA.

Generally, a produced PHA type polyester has reduced water solubility because of the presence of hydrophobic atomic groups such as a 4-vinylalkyl group derived from of 3-hydroxy-ω-alkenoic acid unit in the side chain, and is accumulated in cells producing PHA, and can easily be separated from the culture medium by culturing cells and collecting the cells producing and accumulating the desired PHA type polyester. After the collected cells are washed and dried, the desired PHA type polyester can be collected.

In addition, polyhydroxyalkanoate is usually accumulated in cells of such a microorganism capable of producing PHA. For the method of collecting desired PHA from these microorganism cells, a method that is usually used may be adopted. For example, extraction with an organic solvent such as chloroform, dichloromethane and acetone is most convenient. Other than the above described solvents, dioxane, tetrahydrofuran and acetonitrile may be used. In addition, in a working environment in which use of any organic solvent is not preferred, a method in which in stead of solvent extraction, any treatment selected from the following may be used: a treatment by surfactants such as SDS, a treatment by enzymes such as lysozyme, a treatment by chemicals such as hypochlorites, ammonium and EDTA, an ultrasonic disruption method, a homogenizer method, a pressure disruption method, a bead impulse method, a grinding method, a pounding method and a freeze-thaw method is used to physically disrupt microorganism cells, followed by removing cell components other than PHA to collect PHA.

As an example, the composition of an inorganic salt medium (M9 medium), which is used in the examples described later, is shown below.

<Composition of M9 Culture Medium>

Na₂HPO₄: 6.3

KH₂PO₄: 3.0

NH₄Cl: 1.0

NaCl: 0.5

(by g/L, pH=7.0).

Further, for ensuring satisfactory propagation of cells and associated improvement of productivity of PHA, essential trace elements such as essential trace metal elements should be added in an appropriate amount to an inorganic salt culture medium such as the above described M9 culture medium, and it is very effective to add a solution of trace components to about 0.3% (v/v), of which composition is shown below. The addition of such a trace component solution supplies trace metal elements for use in propagation of the microorganism.

(Composition of Trace Component Solution) nitrilotriacetic acid: 1.5; MgSO₄: 3.0; MnSO₄: 0.5; NaCl: 1.0; FeSO₄: 0.1; CaCl₂: 0.1; COCl₂: 0.1; ZnSO₄: 0.1; CuSO₄: 0.1; AlK(SO₄)₂: 0.1; H₂BO₃: 0.1; Na₂MoO₄: 0.1; NiCl₂: 0.1 (g/L).

Further, in addition to ω-alkenoic acid represented by the chemical formula (20), ω-substituted alkanoic acid represented by the following chemical formula (21) or ω-cyclohexylakanoic acid represented by the following chemical formula (22) may be added to the culture medium as the substrate for production of desired polyhydroxyalkanoate, whereby polyhydroxyalkanoate containing a 3-hydroxy-ω-substituted alkanoic acid unit represented by the following chemical formula (6) or a 3-hydroxy-ω-cyclohexylalkanoic acid unit represented by the following chemical formula (7) in addition to the 3-hydroxy-ω-alkenoic acid unit represented by the chemical formula (19) can be produced. It is desirable that the contents of ω-alkenoic acid represented by the chemical formula (20), ω-substituted alkanoic acid compound represented by the chemical formula (21) and ω-cyclohexylakanoic acid compound represented by the chemical formula (22) are in the range of 0.01% to 1% (w/v), more preferably 0.02% to 0.2% (w/v).

Here the chemical formulas (6), (7), (22) and (21) are as follows 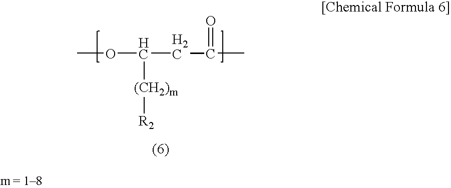
wherein m is an integer selected from the range shown in the same chemical formula, R₂ contains a residue having either a phenyl or thienyl structure, when more than one unit exists, m and R₂ may differ from unit to unit; 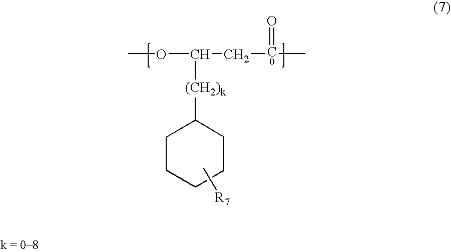
wherein R₇ represents a substitute in the cyclohexyl group and is an H atom, a CN group, an NO₂ group, a halogen atom, a CH₃ group, a C₂H₅ group, a C₃H₇ group, 5 a CF₃ group, C₂F₅ group or a C₃F₇ group; and k is an integer selected from the range shown in the same chemical formula , and when more than one unit exists, R₇ and k may differ from unit to unit as a raw material. 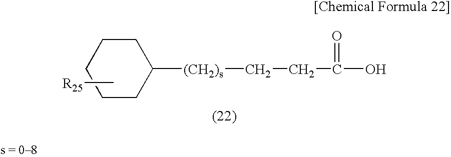
wherein R₂₅ represents a substituent group in the cyclohexyl group, and is an H atom, CN group, NO₂ group, halogen atom, CH₃ group, C₂H₅ group, C₃H₇ group, CF₃ group, C₂F₅ group or C₃F₇ group, and s is an integer selected from the range shown in the chemical formula, 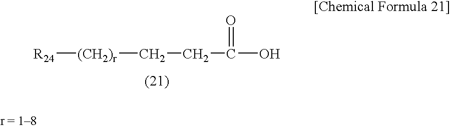
wherein r is an integer selected from the range shown in the chemical formula; and R₂₄ contains a residue having either a phenyl and thienyl structure, is represented by any of the following Chemical Formulae (8), (9), (10), (11), (12), (13), (14),. (15), (16), (17) and (18), and may differ from unit to unit when more than one unit exits; 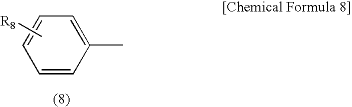
wherein R₈ represents a substituent on the aromatic ring and is an H atom, a halogen atom, a CN group, an NO₂ group, a CH₃ group, a C₂H₅ group, a C₃H₇ group, a CH═CH₂ group, COOR₉ (R₉ represents any one of H, Na and K atoms), a CF₃ group, a C₂F₅ group or a C₃F₇ group, and when more than one unit exists, R₈ may differ from unit to unit, 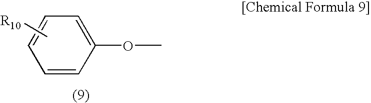
wherein R₁₀ represents a substituent on the aromatic ring and is an H atom, a halogen atom, a CN group, an NO₂ group, a CH₃ group, a C₂H₅ group, a C₃H₇ group, an SCH₃ group, a CF₃ group, a C₂F₅ group or a C₃F₇ group, and when more than one unit exists, R₁₀ may differ from unit to unit, 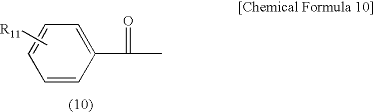
wherein R₁₁ represents a substituent on the aromatic ring and is an H atom, a halogen atom, a CN group, an NO₂ group, a CH₃ group, a C₂H₅ group, a C₃H₇ group, a CF₃ group, a C₂F₅ group or a C₃F₇ group, and when more than one unit exists, R₁l may differ from unit to unit, 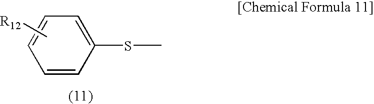
wherein R₁₂ represents a substituent on the aromatic ring and is an H atom, a halogen atom, a CN group, an NO₂ group, a COOR₁₃, an SO₂R₁₄ (R₁₃ represents any one of an H atom, an Na atom, a K atom, a CH₃ group and a C₂H₅ group and R₁₄ represents any one of an OH group, an ONa group, an OK group, a halogen atom, an OCH₃ group and OC₂H₅ group), a CH₃ group, a C₂H₅ group, a C₃H₇ group, a (CH₃)₂—CH group or a (CH₃)₃—C group, and when more than one unit exists, R₁₂ may differ from unit to unit, 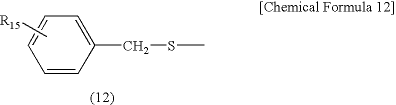
wherein R₁₅ represents a substituent on the aromatic ring and is an H atom, a halogen atom, a CN group, an NO₂ group, a COOR₁₆, an SO₂R₁₇ (R₁₆ represents any one of an H atom, an Na atom, a K atom, a CH₃ group and a C₂H₅ group and R₁₇ represents any one of an OH group, an ONa group, an OK group, a halogen atom, an OCH₃ group and OC₂H₅ group), a CH₃ group, a C₂H₅ group, a C₃H₇ group, a (CH₃)₂—CH group or a (CH₃)₃—C group, and when more than one unit exists, R₁₅ may differ from unit to unit, 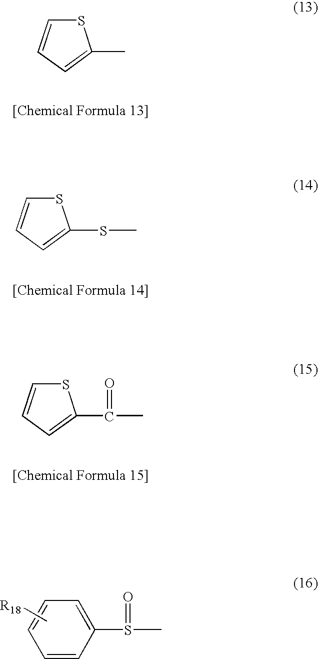
wherein R₁₈ represents a substituent on the aromatic ring and is an H atom, a halogen atom, a CN group, an NO₂ group, a COOR₁₉, an SO₂R₂₀ (R₁₉ represents any one of an H atom, an Na atom, a K atom, a CH₃ group and a C₂H₅ group and R₂₀ represents any one of an OH group, an ONa group, an OK group, a halogen atom, an OCH₃ group and OC₂H₅ group), a CH₃ group, a C₂H₅ group, a C₃H₇ group, a (CH₃)₂—CH group or a (CH₃)₃—C group, and when more than one unit exists, R₁₈ may differ from unit to unit, 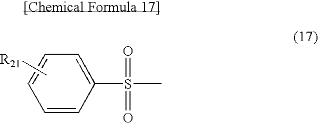
wherein R₂₁ represents a substituent on the aromatic ring and is an H atom, a halogen atom, a CN group, an NO₂ group, a COOR₂₂, an SO₂R₂₃ (R₂₂ represents any one of an H atom, an Na atom, a K atom, a CH₃ group and a C₂H₅ group and R₂₃ represents any one of an OH group, an ONa group, an OK group, a halogen atom, an OCH₃ group and OC₂H₅ group), a CH₃ group, a C₂H₅ group, a C₃H₇ group, a (CH₃)₂—CH group or a (CH₃)₃—C group, and when more than one unit exists, R₂₁ may differ from unit to unit,

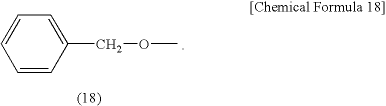

Alternatively, polyhydroxyalkanoate according to the present invention having a 3-hydroxy-ω-carboxyalkanoic acid unit represented by formula (1) and other unit represented by formula (6) or (7) together in the molecule can be prepared by hydrolysis in the presence of an acid or base or by hydrocracking or catalytic cracking of a polyhydroxyalkanoate copolymer containing in the molecule a unit represented by formula (6) or (7) and a 3-hydroxy-ω-carboxyalkanoic acid unit represented by the chemical formula 23: 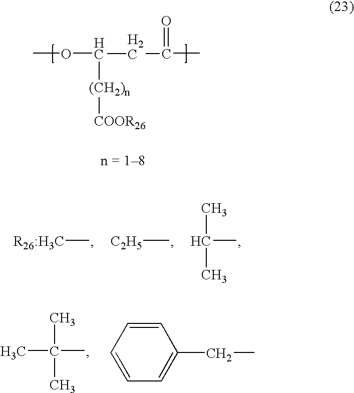
wherein n is an integer selected from the range shown in the same chemical formula, R₂₆ is any one of the residues shown in the formula, when more than one unit exists, n and R₁ may differ from unit to unit.

What is important in the structure of polyhydroxyalkanoates used in this invention is that it has a unit having an aliphatic carboxylic acid or its derivative as a side chain, just like the monomer units represented by the chemical formula (1). The units having an anionic or electron attractive group are preferable to further improve the negatively charged properties of charge controlling agents; in actuality, the charge controlling agent of this invention has superior negatively charged properties.

Polyhydroxyalkanoate use in the present invention has good compatibility with the binder resin and excellent compatibility particularly with polyester type binder resin. Since the toner containing polyhydroxyalkanoate according to the present invention has a high specific charge level and is excellent in stability with time, it provides clear images stably in electrostatic recording even after being stored for a long time period. PHA of the invention can be used for both black and color toners of negative chargeability because of its colorlessness and negative-electrifiability.

In addition, by properly selecting the type and composition ratio of monomer units constituting polyhydroxyalkanoate according to the present invention, wide range compatibility control is made possible.

If a resin composition in which the charge controlling agent is put in micro-phase separation state in a toner binder, no electric continuity is formed in the toner so that electric charge can stably be maintained. In addition, polyhydroxyalkanoate according to the present invention contains no heavy metals, and therefore when the toner is produced by suspension polymerization or emulsion polymerization, polymerization inhibition due to the presence of heavy metals, as found in the case of a metal-containing charge controlling agent, does not occur, thus making it possible to produce a toner stably.

<Addition of PHA to Toner>

In the present invention, the method for adding the above compound to a toner may be a method of internal addition to the toner and a method of external addition to the toner. The addition amount of the internal addition is generally 0.1 to 50% by weight, preferably 0.3 to 30% by weight, and further preferably 0.5 to 20% by weight as the weight ratio of the toner binder and the charge controlling agent. If it is lower than 0.1% by weight, the improvement degree of the charging property of the toner is insignificant and thus not preferable. Whereas, if it is higher than 50% by weight, it is not preferably from an economical point of view. Further, in the case of the external addition, the weight ratio of the toner binder and the charge controlling agent is preferably 0.01 to 5% by weight, and it is particularly preferable that the compound is mechanochmically fixed on the surface of the toner. In addition, polyhydroxyalkanoate according to the present invention may be used in combination of a known charge controlling agent.

The number average molecular weight of polyhydroxyalkanoate according to the present invention is usually 1000 to 1000000, preferably 1000 to 300000. If it is less than 1000, the compound is completely compatible with the toner binder to make it difficult to form a discontinuous domain, resulting in an insufficient charge level, and the fluidity of the toner is adversely affected. Further, if it is higher than 500000, dispersion in the toner becomes difficult.

The molecular weight of polyhydroxyalkanoate according to the present invention was measured by GPC (gel permeation chromatography). As a specific GPC measurement method, the above polyhydroxyalkanoate is previously dissolved in a solvent capable of dissolving the same, measurements are made with a similar mobile phase. A differential diffraction detector (R1), ultraviolet detector (UV) or the like was used as a detector, and a molecular weight distribution was determined from an analytical curve of a standard polystyrene resin. The solvent may be selected from those capable of dissolving a polymer such as dimethyl formaldehyde (DMF) containing 0.1% by mass of LiBr, dimethyl sulfoxide (DMSO), chloroform, tetrahydrofuran (THF), toluene, hexafluoro isopropanol (HFIP) and the like.

In addition, in the present invention, the above polyhydroxyalkanoate with the ratio (Mw/Mn) of the weight average molecular weight (Mw) to the number average molecular weight (Mn) measured as described above being in the range of from 1 to 10 are preferably used.

Polyhydroxyalkanoate to be used in the present invention has a melting point preferably in the range of from 20 to 150° C., especially preferably from 40 to 150° C., or has no melting point but a glass transition temperature in the range of from 20 to 150° C., especially preferably from 40 to 150° C. If the foregoing melting point is lower than 20° C. or the glass transition temperature with no melting point is lower than 20° C., the fluidity and the storage property of the toner are often adversely affected. Whereas if the foregoing melting point is higher than 150° C. or the glass transition temperature with no melting point is higher than 150° C., the charge controlling agent becomes difficult to be kneaded with the toner and the charge level distribution becomes broad in many cases.

To measure the melting point Tm and the glass transition temperature Tg in this case, a high precision and internally heating input compensation type differential scanning calorimeter, for example, DSC-7 from Perkin Ermer Co., may be employed.

Regarding the toner binder and the electrostatic latent image developing toner of the present invention, the weight ratio of the toner binder and the charge controlling agent is generally 0.1 to 50% by weight, preferably 0.3 to 30% by weight, and more preferably 0.5 to 20% by weight. Regarding the composition ratio of the electrostatic latent image developing toner of the present invention, generally the foregoing charge controlling agent is in the range of from 0.1 to 50% by weight, the toner binder is in the range of from 20 to 95% by weight, and a coloring material is in the range of from 0 to 15% by weight with respect to the weight of the toner and based on the necessity, a magnetic powder (a powder of a ferromagnetic metal such as iron, cobalt, nickel and the like and a compound such as magnetite, hematite, ferrite and the like) functioning as a coloring material may be added in an amount not more than 60% by weight. Further, various additives [a lubricant (polytetrafluoroethylene, a lower molecular weight polyolefin, an aliphatic acid or its metal salt or amide, and the like) and other charge controlling agents (metal-containing azo dye, metal salcylate, etc.)] may be contained. In addition, in order to improve the fluidity of the toner, a hydrophobic colloidal silica fine powder may also be employed. The amounts of these additives are generally not more than 10% by weight on the bases of the toner weight.

In the toner of the present invention, it is preferable for at least some of the toner binder to form a continuous phase and at least some of the charge controlling agent to form discontinuous domain. As compared with the case where the charge controlling agent has complete compatibility with the toner binder without forming the discontinuous domain, the added charge controlling agent is easily exposed to the surface and effective even in a small amount. The dispersion particle diameter of the domain is preferably 0.01 to 4 μm and more preferably 0.05 to 2 μm. If it is bigger than 4 μm, the dispersibility becomes insufficient and the charge level distribution becomes broad and the transparency of the toner is deteriorated. Whereas, if the dispersion particle diameter is smaller than 0.01 μm, it becomes similar to the case where the charge controlling agent has complete compatibility with the binder without forming discontinuous domain, a large amount of the charge controlling agent is required to be added. That at least some of the foregoing charge controlling agent forms the discontinuous domain and the dispersion particle size can be observed by observing a specimen of the toner with a transmission electron microscope. In order clearly observe the interface, it is also effective to carry out observation of a toner specimen by electron microscope after the specimen is dyed with ruthenium tetraoxide, osmium tetraoxide and the like.

Further, for the purpose of reducing the particle diameter of the discontinuous domain formed by polyhydroxyalkanoate according to the present invention, a polymer compatible with polyhydroxyalkanoate according to the present invention and also with the toner binder may be added as a compatible agent. The compatibility enhancing agent is, among other things, a polymer comprising mutually graft- or block-polymerized polymer chains containing at least 50% by mol of monomers having practically similar structure to that of the constituent monomers of polyhydroxyalkanoate according to the present invention and polymer chains containing at least 50% by mol of monomers having practically similar structure to that of the toner binder. The amount of the compatible agent to be used is generally not more than 30% by weight and preferably 1 to 10% by weight, with respect to polyhydroxyalkanoate according to the present invention.

<Other Constituent Materials>

Other constituent materials constituting the electrostatic latent image developing toner of the present invention will be described below. (Binder Resin) First, as a binder resin, any resin may be used without any particular restrictions if it is generally used for production of a toner. Also, the charge controlling agent of the present invention may previously be mixed with the binder resin to be used as a toner binder composition of the present invention having charge controlling capability before production of the toner. For example, as the binder resin, styrene-based polymers, polyester-based polymers, epoxy-based polymers, polyolefin-based polymers, and polyurethane-based polymers, and the like can be exemplified and they are used alone or while being mixed with one another.

The styrene-based polymers may be styrene-(meth)acrylic acid ester copolymers and copolymers of these copolymers with other monomers copolymerizable with them; copolymers of styrene with diene type monomers (butadiene, isoprene and the like) and copolymers of these copolymers with other monomers copolymerizable with them; and the like. The polyester-based polymers may be condensation polymerization products of aromatic dicarboxylic acid and aromatic diol alkylene oxide addition products and the like. The epoxy-based polymers may be reaction products of aromatic diols and epichlorohydrin and their modified products. The polyolefin-based polymers may be polyethylene, polypropylene, and copolymer chains of these polymers with monomers polymerizable with them. The polyurethane-based polymers may be addition polymerization products of aromatic diisocyanates and aromatic diol alkylene oxide addition products and the like.

Practical examples of the binder resin to be used in the present invention are polymers of the following polymerizable monomers or their mixtures or copolymerization products produced from two or more kinds of the following polymerizable monomers. Such polymers are more particularly, for example, styrene-based polymers such as styrene-acrylic acid copolymer, styrene-methacrylic acid copolymer, and the like; polyester-based polymers; epoxy-based polymers; polyolefin-based polymers; and polyurethane-based polymers and they are preferably used.

Practical examples of the polymerizable monomers are styrene and its derivatives such as styrene, o-methylstyrene, p-methylstyrene, p-methoxystyrene, p-phenylstyrene, p-chlorostyrene, 3,4-dichlorostyrene, p-ethylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, and the like; ethylenic unsaturated monoolefins such as ethylene, propylene, butylene, isobutylene and the like; unsaturated polyenes such as butadiene and the like; vinyl halides such as vinyl chloride, vinylidene chloride, vinyl bromide, vinyl fluoride and the like; vinyl esters such as vinyl acetate, vinyl propionate, vinyl benzoate and the like; α-methylene aliphatic monocarboxylic acid esters such as methyl methacrylate, ethyl methacrylate, propyl methacrylate, n-butyl methacrylate, isobutyl methacrylate, n-octyl methacrylate, dodecyl methacrylate, 2-ethylhexyl methacrylate, stearyl methacrylate, phenyl methacrylate, dimethylaminoethyl methacrylate, diethylaminoethyl methacrylate, and the like; acrylic acid esters such as methyl acrylate, ethyl acrylate, n-butyl acrylate, isobutyl acrylate, propyl acrylate, n-octyl acrylate, dodecyl acrylate, 2-ethylhexyl acrylate, stearyl acrylate, 2-chloroethyl acrylate, phenyl acrylate, and the like; vinyl ethers such as vinyl methyl ether, vinyl ethyl ether, vinyl isobutyl ether, and the like; vinyl ketones such as vinyl methyl ketone, vinyl hexyl ketone, methyl isopropenyl ketone, and the like; N-vinyl compounds such as N-vinylpyrrole, N-vinylcarbazole, N-vinylindole, N-vinylpyrrolidone and the like; vinyl naphthalenes; acrylic acid or methacrylic acid derivatives such as acrylonitrile, methacrylonitrile, acrylamide and the like; the above-described α, β-unsaturated acid esters; bibasic acid diesters; dicarboxylic acids such as maleic acid, methyl maleate, butyl maleate, dimethyl maleate, phthalic acid, succinic acid, terephthalic acid, and the like; polyols compounds such as ethylene glycol, diethylene glycol, triethylene glycol, 1,2-propylene glycol, 1,3-propylene glycol, 1,4-butanediol, 1,6-hexanediol, bisphenol A, hydrogenated bisphenol A, polyoxyethylene-modified bisphenol A and the like; isocyanates such as p-phenylene diisocyanate, p-xylylene diisocyanate, 1,4-tetramethylene diisocyanate, and the like; amines such as ethylamine, butylamine, ethylenediamine, 1,4-diaminobenzene, 1,4-diaminobutane, monoethanolamine, and the like; epoxy compounds such as diglycidyl ether, ethylene glycol diglycidyl ether, bisphenol A glycidyl ether, hydroquinone glycidyl ether, and the like.

(Cross-Linking Agent)

In the case of producing the binder resin to be used in the present invention, based on the necessity, the following cross-linking agent may be used. Examples of a bifunctional cross-linking agent are divinylbenzene, bis(4-acryloxypolyethoxyphenyl)propane, ethylene glycol diacrylate, 1,3-butylene glycol diacrylate, 1,4-butanediol diacrylate, 1,5-pentanediol diacrylate, 1,6-hexanediol diacrylate, neopentyl glycol diacrylate, diethylene glycol diacrylate, triethylene glycol diacrylate, tetraethylene glycol diacrylate, respective diacrylates of polyethylene glycol #200, #400, #600, dipropylene glycol diacrylate, polypropylene glycol diacrylate, polyester type diacrylate (MANDA Nippon Kayaku), and those obtained by replacing these exemplified acrylates with methacrylates.

Examples of bi- or higher polyfunctional cross-linking agent are pentaerythritol triacrylate, trimethylolethane triacrylate, trimethylolpropane triacrylate, tetramethylolmethane tetraacrylate, oligoester acrylates or methacrylates, 2,2-bis(4-methacryloxy, polyethoxyphenyl)propane, diallyl phthalate, triallyl cyanurate, triallyl azocyanurate, triallyl isocyanurate, triallyl trimellitate diaryl chlorendate, and the like.

(Polymerization Initiator)

In the case of producing the binder resin to be used in the present invention, the following polymerization initiators may be used based on the necessity: for example, tert-butyl peroxy-2-ethylhexanoate, cumine perpivalate, tert-butyl peroxylaurate, benzoyl peroxide, lauroyl peroxide, octanoyl peroxide, di-tert-butyl peroxide, tert-butylcumyl peroxide, dicumyl peroxide, 2,2′-azobis isobutyronitrile, 2,2′-azobis(2-methylbutyronitrile), 2,2′-azobis(2,4-dimethylvaleronitrile), 2,2′-azobis(4-methoxy-2,4-dimethylvaleronitrile), 1,1-bis(tert-butylperoxy)-3,3,5-trimethylcyclohexane, 1,1-bis(tert-butylperoxy)cyclohexane, 1,4-bis(tert-butylperoxycarbonyl)cyclohexane, 2,2-bis(tert-butylperoxy)octane, n-butyl 4,4-bis(tert-butylperoxy)valirate, 2,2-bis(tert-butylperoxy)butane, 1,3-bis(tert-butylperoxyisopropyl)benzene, 2,5-dimethyl-2,5-di(tert-butylperoxy)hexane, 2,5-dimethyl-2,5-di(tert-butylperoxy)hexane, 2,5-dimethyl-2,5-di(benzoylperoxy)hexane, di-tert-butyldiperoxy isophthalate, 2,2-bis(4,4-di-tert-butylperoxycyclohexyl)propane, di-tert-butylperoxy-α-methylsuccinate, di-tert-butyl peroxydimethylglutarate, di-tert-butyl peroxyhexahydroterephthalate, di-tert-butyl peroxyazelate, 2,5-dimethyl-2,5-di(tert-butylperoxy)hexane, diethylene glycol bis(tert-butylperoxycarbonate), di-tert-butyl peroxytrimethyladipate, tris(tert-butylperoxy)triazine, vinyltris(tert-butylperoxy)silane and the like. Each of these compounds may be used alone or in combination. The use amount of them is generally in 0.05 parts by mass or more (preferably 0.1 to 15 parts by mass) to 100 parts by mass of monomers.

(Other Biodegradable Plastics)

In addition, in the present invention, commercially available biodegradable plastics are preferably used. Examples of the biodegradable plastics are “Ecostar”, “Ecostar plus” (produced by Hagiwara Industries, Inc.), “Biopole” (produced by Monsanto Company), “Ajicoat” (Ajinomoto Co., Ltd.), “Placcel”, “Polycaprolactone” (produced by Daicel Chem., Ind., Ltd.), “SHOWLEX”, “Bionolle” (produced by Showa Denko K.K.), “Lacty” (produced by Shimadzu Corporation), “Lacea” (produced by Mitsui Chemicals, Inc.) and the like.

It is preferable for the combinations of the binder resin and the charge controlling agent of the present invention that the structure of the polymers of the binder resin and the polymer structure of the polymer chain of the charge controlling agent are similar to each other as much as possible. If the structure of the polymers of the binder resin and the polymer structure of the polymer chain of the charge controlling agent are considerably dissimilar to each other, the charge controlling agent tends to be dispersed insufficiently in the binder resin.

The weight ratio of the charge controlling agent of the present invention to be internally added to the binder resin is generally 0.1 to 50% by weight, preferably 0.3 to 30% by weight, and more preferably 0.5 to 20% by weight. If the weight ratio of the charge controlling agent to be internally added is lower than 0.1% by weight, the charge level becomes low and if the weight ratio is higher than 50% by weight, the charge stability of the toner is deteriorated.

<Coloring Agent>

Any coloring agent generally used for production of a toner may be used as the coloring agent composing the electrostatic latent image developing toner of the present invention without particular restrictions. For example, carbon black, titanium white, and any other pigment and/or dye may be used.

For example, in the case the electrostatic latent image developing toner of the present invention is used for a magnetic color toner, examples of the coloring agent to be employed are C.I. Direct Red 1, C.I. Direct Red 4, C.I. Acid Red 1, C.I. Basic Red 1, C.I. Mordant Red 30, C.I. Direct Blue 1, C.I. Direct Blue 2, C.I. Acid Blue 9, C.I. Acid Blue 15, C.I. Basic Blue 3, C.I. Basic Blue 5, C.I. Mordant Blue 7, C.I. Direct Green 6, C.I. Basic Green 4, C.I. Basic Green 6 and the like. Examples of the pigment are Chrome Yellow, Cadmium Yellow, Mineral Fast Yellow, Naval Yellow, Naphthol Yellow S, Hansa Yellow G, Permanent Yellow NCG, Tartrazine Yellow Lake, Chrome Orange, Molybenum Orange, Permanent Orange GTR, Pyrazolone Orange, Benzidine Orange G, Cadmium Red, Permanent Red 4R, Watching Red calcium salt, Eosine Lake, Brilliant Carmine 3B, Manganese Violet, Fast Violet B, Methyl Violet Lake, Prussian Blue, Cobalt Blue, Alkali Blue Lake, Victoria Blue Lake, Phthalocyanine Blue, Fast Sky Blue, Indanthrene Blue BC, Chrome Green, chromium oxide, Pigment Green B, Malachite Green Lake, Final Yellow Green G and the like.

In the case the electrostatic latent image developing toner of the present invention is used for a two-component type full color toner, the following coloring agents can be used. For example, coloring pigments for magenta toners are C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48, 49, 50, 51, 52, 53, 54, 55, 57, 58, 60, 63, 64, 68, 81, 83, 87, 88, 89, 90, 112, 114, 122, 123, 163, 202, 206, 207, 209, C.I. Pigment Violet 19, C.I. Vat Red 1, 2, 10, 13, 15, 23, 29, 35 and the like.

In the present invention, the above-exemplified pigments may be used alone, but it is more preferable that they are used in combination with dyes for improving the clearness from the aspect of the full color image quality. In such a case, the examples of usable magenta dyes are oil-soluble dyes such as C.I. Solvent Red 1, 3, 8, 23, 24, 25, 27, 30, 49, 81, 82, 83, 84, 100, 109, 121, C.I. Disperse Red 9, C.I. Solvent Violet 8, 13, 14, 21, 27, C.I. Solvent Red 1, 3, 8, 23, 24, 25, 27, 30, 49, 81, and C.I. Disperse Violet 1 and the like; and basic dyes such as C.I. Basic Red 1, 2, 9, 12, 13, 14, 15, 17, 18, 22, 23, 24, 27, 29, 32, 34, 35, 36, 37, 38, 39, 40, C.I. Basic Violet 1, 3, 7, 10, 14, 15, 21, 25, 26, 27, 28 and the like.

As other coloring pigments, examples of cyan coloring pigments are C.I. Pigment Blue 2, 3, 15, 16, 17, C.I. Vat Blue 6, C.I. Acid Blue 45, copper-phthalocyanine pigments having a phthalocyanine skeleton containing substituents of phthalimidomethyl groups in number of 1 to 5, and the like.

Examples of yellow coloring pigments are C.I. Pigment Yellow 1, 2, 3, 4, 5, 6, 7, 10, 11, 12, 13, 14, 15, 16, 17, 23, 65, 73, 83, C.I. Vat Yellow 1, 3, 20 and the like.

The above-described dyes and pigments may be used solely or may be used while being optionally mixed with one another to obtain desired hue of the toner. When considering the environmental conservation and the safety to the human body, various food colors can be suitably used. The content of the coloring agents in the toner may widely altered depending on the desired coloration effects. Generally, in order to obtain the best toner properties, that is, in consideration of the printing coloration capability, the toner shape stability, and the toner scattering, these coloring agents are used at a ratio in the range of from 0.1 to 60 parts by mass, preferably 0.5 to 20 parts by mass with respect to 100 parts by mass of the binder resin.

<Other Components of Toner>

In the toner of the present invention may contain the following compounds other than the foregoing binder resin and the coloring agent components, to an extent (within a ratio less than the content of the binder resin) in which no undesired effect is caused in the present invention. Examples of such compounds include silicone resin; polyester; polyurethane; polyamide; epoxy resin; poly(vinyl butyral); rosin; modified rosin; terpene resin; phenolic resin; aliphatic or alicyclic hydrocarbon resin such as lower molecular weight polyethylene and lower molecular weight polypropylene; aromatic type petroleum resin; and chlorinated paraffin and paraffin waxes. Among them, preferable waxes to be used are practically lower molecular weight polypropylene and its byproducts, lower molecular weight polyester, and ester type wax and aliphatic derivatives. Among these waxes, waxes fractionated based on the molecular weight of the waxes by various methods are also preferably used in the present invention. Further, after fractionation, the waxes may be modified to control the acid values, block-copolymerized, or graft-modified.

Specially, in the toner of the present invention, in the case such wax components as described above are added and these wax components are found practically dispersed in the binder resin in spherical and/or spindly island state when the section of the toner was observed by a transmission electron microscope, the toner has excellent properties.

<Method of Producing Toners>

Any conventionally known method may be employed for a practical method for producing an toner of the present invention having the constitution as described above. The toner of the present invention can be produced, for example, by a so-called pulverization method for obtaining a toner through the following steps. Specifically, resin materials such as binder resin, and a charge controlling agent to be added as necessary, a wax, are sufficiently mixed by a mixer such as a Henshel mixer, a ball mill and the like and then melted and kneaded using a thermally kneading apparatus such as heating rolls, a kneader, an extruder and the like to make the resin material compatible with one another, and as coloring agents, pigments, dyes, or magnetic materials and also additives such as metal compounds to be added as necessary are dispersed or dissolved in the resulting mixture, and after solidification of the mixture by cooling, the obtained solidified product is pulverized by a pulverizing apparatus such as a jet mill, a ball mill and the like and then classified to obtain an toner of the present invention with a desired particle size. In the above-described classification step, from an aspect of productivity, a multi-step classification apparatus is preferably used.

In addition, the toner of the present invention with a desired particle size can be obtained by mixing and stirring the binder resin and the charge controlling agent in a solvent (e.g., aromatic hydrocarbons such as toluene, xylene and the like; halogen compounds such as chloroform, ethylene dichloride, and the like; ketones such as acetone, methyl ethyl ketone, and the like; amides such as dimethylformamide and the like), and then adding the resulting mixture to water to re-precipitate the solid, then filtering and drying the solid, and further pulverizing it by a pulverizing apparatus such as a jet mill, a ball mill, and the like, and finally classifying the pulverized matter. In the above-described classification step, from an aspect of productivity, a multi-step classification apparatus is preferably used.

In addition, the toner of the present invention can be produced by a so-called polymerization method as follows. That is, in this case, a polymerizable monomer of a binder resin, a charge controlling agent and as coloring agents, pigments, dyes, or magnetic materials and also based on the necessity, additives such as a cross-linking agent, a polymerization initiator, waxes, other binder resins, and others are mixed and dispersed and in the presence of a surfactant or the like, the mixture is subjected to suspension polymerization to obtain a polymerized and colored resin particles, and after the obtained particles are separated by solid-liquid separation, the particles are dried and classified if necessary to obtain a toner of the present invention with a desired particle size. Furthermore, colored fine particles containing no charge controlling agent is produced by the above-described manner and then either solely or together with an externally added agent such as colloidal silica, the above polyhydroxyalkanoate may be attached and fixed to the surface of the particle by a mechanochemical method or the like.

<Externally Added Silica Agent>

In the present invention, a silica fine powder is preferably added externally to the toner produced in a manner as described above for improving the charge stability, development characteristic, fluidity and durability. The silica fine powder to be employed in this case can provide desirable effects if it has a specific surface area of 20 m²/g or higher (especially 30 to 400 m²/g) measured based on the nitrogen adsorption by the BET method. The content of the silica fine powder to be added is preferably 0.01 to 8 parts by weight, more preferably 0.1 to 5 parts by weight, with respect to 100 parts by weight of the toner particles. In this case, based on the necessity, the silica fine powder to be used in the case is preferably treated, for the purpose of controlling the hydrophobicity and charge properties, with silicone varnish, variously modified silicone varnish, silicone oil, variously modified silicone oil, a silane coupling agent, a silane coupling agent having a functional group, and other organosilicon compounds. These treatment agent may be used by mixing.

<Inorganic Powder>

Further, in order to improve the development capability and the durability, the following inorganic powder is preferably added. Examples of the powder are oxides of metals such as magnesium, zinc, aluminum, cerium, cobalt, iron, zirconium, chromium, manganese, strontium, tin, antimony and the like; compounded metal oxides such as calcium titanate, magnesium titanate, and strontium titanate; metal salts such as calcium carbonate, magnesium carbonate, and aluminum carbonates; clay minerals such as kaolin; phosphate compounds such as apatite; silicon compounds such as silicon carbide, and silicon nitride; and carbon powder such as carbon black and graphite. Among them, fine powders of zinc oxide, aluminum oxide, cobalt oxide, manganese dioxide, strontium titanate, and magnesium titanate are preferably used.

<Lubricant>

Further, the following lubricant powder may be added to the toner. For example, fluoro resin such as Teflon, poly(vinylidene fluoride) and the like; fluoride compounds such as carbon fluoride; aliphatic acid metal salts such as zinc stearate; aliphatic acid derivatives such as aliphatic acid, aliphatic acid esters and the like; and molybdenum sulfide.

The contents, in a toner, of the binder resins, colorants, charge controlling agents used in the form of a mixture with the binder resin of this invention and those of other additives added as the need arises are very small; however, it is preferable to use the binder resins, colorants, charge controlling agents and other additives each having biodegradability, if possible, taking into consideration their effects on the environment after use.

<Carrier>

The toner of the present invention having the above-described constitution is usable for a variety of conventionally known toners; solely as a non-magnetic one-component developer, as a non-magnetic toner together with a magnetic carrier for composing a magnetic two-component developer, as a magnetic toner to be used solely for a magnetic mono-component toner. In this case, as the carrier to be used for the two-component development, any conventionally known carrier may be used. More particularly, particles of surface-oxidized or non-oxidized metals such as iron, nickel, cobalt, manganese, chromium and rare earth metals, their alloys and oxides and having an average particle size of 20 to 300 μm may be used as the carrier particles. Further, the carrier to be used in the present invention are preferably the above-described carrier particle whose surface bears or is coated with a substance such as styrene-based resin, acrylic resin, silicone resin, fluoro resin, polyester resin and the like.

<Magnetic Toner>

The toner of the present invention may be a magnetic toner by adding a magnetic material to the toner particles. In this case, the magnetic material may take a role also as a coloring agent. The magnetic material to be used in this case may be iron oxides such as magnetite, hematite, and ferrite; metals such as iron, cobalt, and nickel; alloys of these metals with metals such as aluminum, cobalt, copper, lead, magnesium, tin, zinc, antimony, beryllium, bismuth, cadmium, calcium, manganese, selenium, titanium, tungsten, and vanadium; and their mixtures. The magnetic material to be used in the present invention has an average particle size preferably 2 μm or smaller, more preferably 0.1 to 0.5 μm. The amount to be added to the toner is preferably 20 to 200 parts by weight to 100 parts by weight of the binder resin and especially preferably 40 to 150 parts by weight to 100 parts by weight of the binder resin.

In addition, in order to give high image quality, it is required to precisely develop very small latent image dots and for this purpose, for example, it is preferable that the weight average particle size of the toner of the present invention is controlled so that it is in the range of from 4 to 9 μm. That is, if the toner particle has a weight average particle size smaller than 4 μm, the transfer efficiency is decreased and a large amount of the transfer residual toner tends to remain on a photosensitive member to result in an undesirable cause of uneven and irregular image formation due to fogging and transfer failures. Whereas, if the toner particle has a weight average particle size larger than 9 μm, scattering around letters and line images tends to occur.

In the present invention, the average particle size and the particle size distribution of the toner are measured by using Coulter Counter TA-II model or Coulter Multisizer (manufactured by Coulter Co.) or the like to which an interface (manufactured by Nikka Machine Co.) for outputting the distribution by number, the distribution by volume and a PC9801 personal computer (manufactured by NEC) are connected. As an electrolytic solution to be used at that time, an aqueous 1% NaCl solution is prepared using first-grade sodium chloride. As the electrolytic solution, for example, a commercialized ISOTON R-II (produced by Coulter Scientific Japan Co.) may also be usable. A practical measurement method involves steps of adding 0.1 to 5 mL of a surfactant (preferably an alkylbenzenesulfonic acid salt is used) as a dispersant to 100 to 150 mL of the above-described aqueous solution, further adding 2 to 20 mg of a sample to the resulting solution to obtain a specimen to be measured. At the time of measurement, the electrolytic solution in which the specimen to be measured is suspended is treated for dispersion for 1 to 3 minutes by an ultrasonic dispersing apparatus and then the volume and the number of the toner particles of 2 μm or larger are measured by the foregoing Coulter Counter TA-II model using 100 μm aperture and the distribution by volume and the distribution by number are calculated. Then, the weight average particle size (D4) on the basis of the volume calculated from the distribution by volume according to the present invention and the length average particle size (D1) on the basis of the number calculated from the distribution by number are calculated.

<Charge Level>

In addition, the charge level of the toner of the present invention is preferably in the range of from −10 to <80 μC/g, more preferably from −15 to −70 μC/g per unit weight (two-component method) in improving the transfer efficiency in a transfer method using a transfer member with a voltage applied thereto.

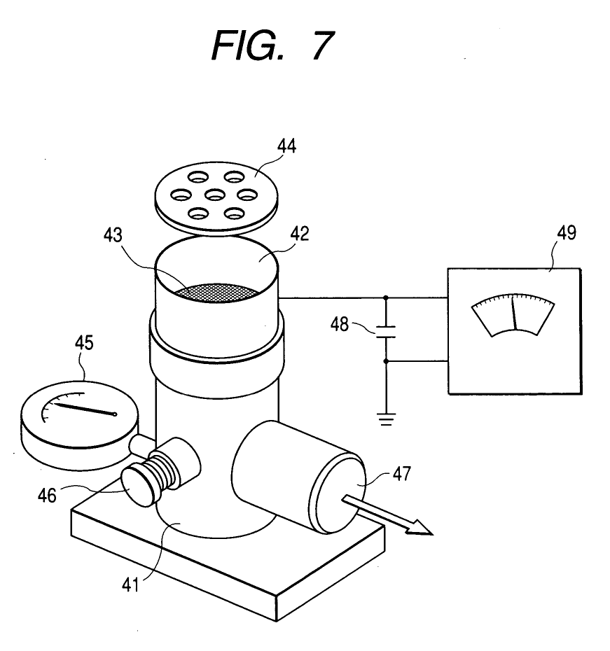

The method of measuring a charge level (a two-component tribo) by the two-component method employed in the present invention will be described as follows. A charge level measuring apparatus illustrated in FIG. 7 is used for the measurement. At first, under a specified environment, EFV 200/300 (produced by Powder Tec Co.) is used as a carrier and a bottle made of a polyethylene with a capacity of 50 to 100 mL is charged with a mixture of 9.5 g of the carrier and 0.5 g of a toner to be measured, set in a shaking apparatus so controlled as to keep the amplitude constant, and shaken for a prescribed period in the shaking conditions of an amplitude of 100 mm and a shaking speed of 100 rpm. Then, 1.0 to 1.2 g of the above mixture is placed in a measurement container 42 made of metal having a 500-mesh screen 43, and the measurement container 42 is covered with a metal lid 44 in the bottom of the charge level measuring apparatus shown in FIG. 7. The total weight of the measurement container 42 at that time is measured and determined as W1 (g). Next, the gas in the container is aspirated through a suction port 47 by an unillustrated aspirator (at least the portion contacting the measurement container 42 is made of an insulator) and an air ventilation adjustment valve 46 is controlled to control the pressure of the vacuum meter 45 to be 2,450 Pa (250 mmAq). Under such a state, aspiration is carried out for 1 minute to suck and remove the toner. The potential of a potentiometer 49 at that time is denoted as V (volt). The reference numeral 48 denotes a capacitor and the capacity is denoted as C (μF). The weight of the entire measurement container after the aspiration is weighed and denoted as W2 (g). The friction charge level (μC/g) of the toner can be calculated according to the following equation from these measurement values.

Friction charge level (μC/g)=C×V/(W1−W2)

<Method for Measuring Molecular Weight of Binder Resin and Molecular Weight Distribution>

The binder resin for use in the constituent material of the toner of the present invention preferably has a peak within the range of from 3,000 to 15,000 in a low molecular weight region of the molecular weight distribution measured by GPC, especially, in the case of production by the pulverization method. That is, if the GPC peak exceeds 15,000 in the low molecular weight region, it sometimes becomes difficult to obtain a toner with a sufficiently improved transfer efficiency. Whereas if binder resin having a GPC peak of less than 3,000 is used, melting takes place easily at the time of surface treatment and therefore it is undesirable.

In the present invention, the molecular weight of the binder resin is measured by GPC (gel permeation chromatography). A practical GPC measurement method is carried out as follows: a toner previously extracted with THF (tetrahydrofuran) solvent for 20 hours using a Soxhlet extractor is used as a sample for measurement. Using columns A-801, 802, 803, 804, 805, 806, and 807 manufactured by Showa Denko K.K. and the calibration curve of standardized polystyrene resins, the molecular weight distribution is measured. Further, in the present invention, it is preferable that the binder resin with the ratio (Mw/Mn) of the weight average molecular weight (Mw) to the number average molecular weight (Mn) measured as described above being in the range of from 2 to 100 is used.

<Glass Transition Temperature of Toner>

Further, the toner of the present invention is preferably adjusted by using a proper material so as to have a glass transition temperature Tg in the range of from 40 to 75° C., more preferably 52 to 70° C., from a viewpoint of fixation and storage stability. In this case, the measurement of the glass transition temperature Tg may be carried out using a high precision and internally heating input compensation type differential scanning calorimeter, for example, DSC-7 manufactured by Perkin Elmer Co., may be employed. The measurement method is carried out according to ASTM D3418-82. In the present invention, when the glass transition temperature Tg is measured, it is preferable that a measurement sample is once heated to cancel the entire hysteresis and then cooled rapidly and again heated at a heating rate of 10° C./min to employ the DSC curve measured during the heating from 0 to 200° C.

<Image Formation Method>

The toner of the present invention having the configuration described above is particularly preferably applied to an image formation method and an apparatus therefor, the method comprising at least an charging step of applying a voltage to a charging member from the outside to charge an electrostatic latent image-holding member, a step of forming an electrostatic latent image on the charged electrostatic latent image-holding member, a development step of developing the electrostatic latent image with the toner to form a toner image on the electrostatic latent image-holding member, a transfer step of transferring the toner image on the electrostatic latent image-holding member to a recording material, and a heat-fixation step of heat-fixing the toner image on the recording material. Alternatively, an image formation method and an apparatus therefor can be used where the transfer step consists of a first transfer step of transferring the toner image on the electrostatic latent image-holding member to an intermediate transfer member and a second transfer step of transferring the toner image on the intermediate transfer member to the recording material.

The culture of microorganisms, the recovery of the PHA from the microorganisms, the resin compositions and the moldings, and in addition, the toner binder resins, the charge controlling agents, etc. of this invention are all not limited to the above described methods.

### EXAMPLES

The present invention will be further described in the following Examples and Comparative Examples. The Examples are not intended to limit the scope of the present invention. The number of parts in each of the following compositions represents part by mass. Moreover, “%” herein represents mass standard, unless otherwise specified.

First, a method for preparing polyhydroxyalkanoate of the present invention comprising a microbiological production step followed by a chemical processing step is shown below (Examples 1 to 5).

### (Example 1)

<Pre-Preparation 1: Biosynthesis of ω-Alkene PHA (1)>

20 shaking flasks (volume: 500 mL) were prepared. Thereafter, 0.5 wt % polypeptone (Wako Pure Chemical Industries, Ltd.), 6 mmol/L 5-phenoxyvaleric acid, and 3.75 mmol/L 10-undecenoic acid were dissolved in 200 mL of the above M9 medium, and the resultant solution was placed in each of the above 500 mL shaking flasks and was then sterilized by an autoclave and cooled to room temperature. Pseudomonas cichorii YN2 was shake-cultured for 8 hours in an M9 medium supplemented with 0.5% polypeptone, and 2 mL of the preculture was added to each of the above prepared media, and cultured at 30° C. for 64 hours. After completion of the culture, they were combined, and cells were recovered by centrifugation. The obtained cells were washed with methanol and then dried. After weighing the dried cells, chloroform was added thereto, and the mixture was stirred at 35° C. for 72 hours to extract a polymer. The chloroform containing the extracted polymer was filtrated through a 0.45 μm membrane filter, and the filtrate was concentrated using an evaporator. The condensate was then reprecipitated with cold methanol, to recover a polymer. Thereafter, the obtained polymer was dried under reduced pressure to obtain a polymer of interest.

The obtained polymer and lyophilized cells (weight of dried cells) were weighed. In the present example, 1,528 mg of PHA (dry weight) was obtained.

The average molecular weight of the obtained PHA was evaluated by gel permeation chromatography (GPC: Tosoh HLC-8220, column: Tosoh TSK-GEL Super HM-H, solvent: chloroform, polystyrene conversion). As a result, number average molecular weight Mn=104,000, and weight average molecular weight Mw=231,000.

Moreover, in order to identify the structure of the obtained PHA, an NMR analysis was carried out under the following conditions:

Measuring apparatus FT-NMR: Bruker DPX 400

Resonance frequency: ¹H=400 MHz

Measuring conditions:

Type of nuclear species: ¹H

Used solvent: TMS/CDCl₃

Temperature: room temperature

As a result, it was confirmed that the obtained PHA was a polyhydroxyalkanoate copolymer comprised of, as monomer units, 3-hydroxy-5-phenoxyvaleric acid, 3-hydroxy-10-undecenoic acid, 3-hydroxy-8-nonenoic acid, and 3-hydroxy-6-heptenoic acid represented by the following chemical formulas (24), (25), (26) and (27) respectively.

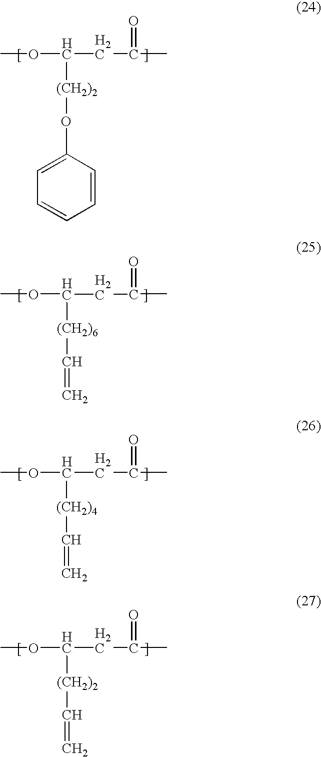

From the ¹H-NMR spectrum, it was confirmed that the proportion of these units was 69 mol % of 3-hydroxy-5-phenoxyvaleric acid, 23 mol % of the total three units, 3-hydroxy-10-undecenoic acid, 3-hydroxy-8-nonenoic acid, and 3-hydroxy-6-heptenoic acid, and 8 mol % of others (straight chain 3-hydroxyalkanoic acid having 4 to 12 carbon atoms, and 3-hydroxyalka-5-enoic acid having 10 or 12 carbon atoms).

From this result, it was confirmed that the obtained PHA contains the unit of 3-hydroxy-10-undecenoic acid as represented by chemical formula (19).

<Synthesis of Aliphatic Carboxy PHA by Oxidative Reaction (1)>

303 mg of polyhydroxyalkanoate obtained by pre-preparation 1 was added into a 200 mL round bottomed flask, and 20 mL of dichloromethane was further added thereto, so that the above compound was dissolved. The resultant product was left under ice bath cooling, and 3 mL of acetic acid and 300 mg of 18-crown-6-ether were then added thereto, followed by stirring. Thereafter, 241 mg of potassium permanganate was slowly added thereto under ice bath cooling, and the mixture was stirred at room temperature for 20 hours. After completion of the reaction, water (50 mL) and sodium hydrogen sulfite were added to the reaction product. Thereafter, 1.0 mol/L (1.0 N) hydrochloric acid was added thereto, so that the mixed solution was adjusted to pH 1. Dichloromethane contained in the mixed solution was removed on an evaporator, and thereafter, the polymer in the solution was recovered. The recovered polymer was washed with 100 mL of methanol and then with 100 mL of pure water three times, and thereafter the polymer was recovered. The recovered polymer was dried under reduced pressure, so as to obtain 247 mg of PHA of interest.

The average molecular weight of the obtained PHA was evaluated by gel permeation chromatography (GPC: Tosoh HLC-8220, column: Tosoh TSK-GEL Super HM-H, solvent: chloroform, polystyrene conversion). As a result, number average molecular weight Mn=29,400, and weight average molecular weight Mw=102,800.

In order to specify the structure of the obtained PHA, an NMR analysis was carried out under the above-described conditions.

As a result, it was confirmed that the obtained PHA was a polyhydroxyalkanoate copolymer comprised of monomer units, 3-hydroxy-5-phenoxyvaleric acid, 3-hydroxy-9-carboxynonanoic acid, 3-hydroxy-7-carboxyheptanoic acid, and 3-hydroxy-5-carboxyvaleric 5 acid represented by the following chemical formulas (24), (28), (29) and (30) respectively.

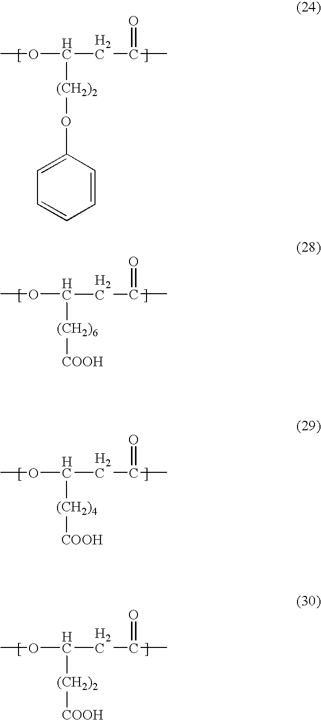

Moreover, in order to calculate the ratio of the units of the obtained PHA, a carboxyl group located at the end of the side chain of PHA was methyl-esterified using trimethylsilyldiazomethane. 50 mg of PHA of interest was added into a 100 mL round bottomed flask, and 3.5 mL of chloroform and 0.7 mL of methanol were then added thereto to dissolve the PHA. 2 mL of 0.63 mol/L trimethylsilyldiazomethane-hexane solution (Tokyo Kasei) was added thereto, followed by stirring at room temperature for 30 minutes. After completion of the reaction, the solvent was removed on an evaporator, and thereafter, a polymer contained in the solution was recovered. The recovered polymer was washed with 50 mL of methanol, and dried under reduced pressure to obtain 49 mg of PHA.

An NMR analysis was carried out by the same method as described above. As a result, it was confirmed that the ratio of the units was 83 mol % of 3-hydroxy-5-phenoxyvaleric acid, 8 mol % of the total three units, 3-hydroxy-9-carboxynonanoic acid, 3-hydroxy-7-heptanoic acid, and 3-hydroxy-5-valeric acid, and 9 molt of others (straight chain 3-hydroxyalkanoic acid having 4 to 12 carbon atoms, and 3-hydroxyalka-5-enoic acid having 10 or 12 carbon atoms).

The above method was scaled up, so as to obtain 50 g of PHA, which was denoted as PHA (1).

### Example 2

<Pre-Preparation 2: Biosynthesis of ω-alkene PHA (2)>

20 shaking flasks (volume: 500 mL) were prepared. Thereafter, 0.5 wt % polypeptone (Wako Pure Chemical Industries, Ltd.), 6 mmol/L 4-cyclohexylbutyric acid, and 3 mmol/L 10-undecenoic acid were dissolved in 200 mL of the above M9 medium, and the resultant solution was placed in each of the above 500 mL shaking flasks and was then sterilized by an autoclave and cooled to room temperature. Pseudomonas cichorii YN2 was shake-cultured for 8 hours in an M9 medium supplemented with 0.5% polypeptone, and 2 mL of the preculture was added to each of the above prepared media, and cultured at 30° C. for 69 hours. After completion of the culture, they were combined, and cells were recovered by centrifugation. The obtained cells were washed with methanol and then dried. After weighing the dried cells, chloroform was added thereto, and the mixture was stirred at 35° C. for 72 hours to extract a polymer. The chloroform containing the extracted polymer was filtrated through a 0.45 μm membrane filter, and the filtrate was concentrated using an evaporator. The condensate was then reprecipitated with cold methanol, to recover a polymer. Thereafter, the obtained polymer was dried under reduced pressure to obtain a polymer of interest.

The obtained polymer and lyophilized cells (weight of dried cells) were weighed. In the present example, 1,433 mg of PHA (dry weight) was obtained.

The average molecular weight of the obtained PHA was evaluated under the same GPC conditions as in Example 1. As a result, number average molecular weight Mn=143,000, and weight average molecular weight Mw=458,000. Moreover, in order to specify the structure of the obtained PHA, an NMR analysis was carried out under the same conditions as in Example 1.

As a result, it was confirmed that the obtained PHA was a polyhydroxyalkanoate copolymer comprised of monomer units: 3-hydroxy-4-cyclohexylbutyric acid, 3-hydroxy-10-undecenoic acid, 3-hydroxy-8-nonenoic acid, and 3-hydroxy-6-heptenoic acid represented by the following chemical formulas (31), (25), (26) and (27) respectively.

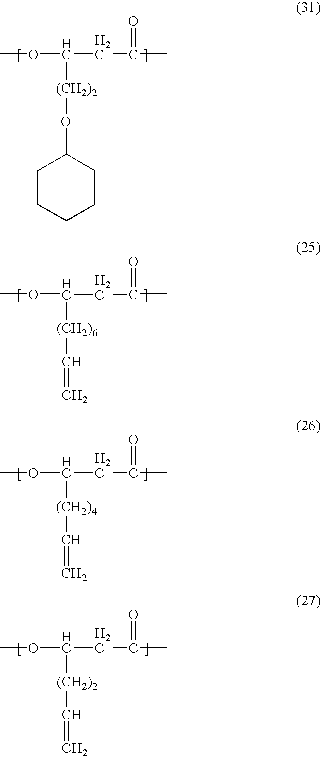

From the ¹H-NMR spectrum, it was confirmed that the proportion of these units was 37 mol % of the total three units, 3-hydroxy-10-undecenoic acid, 3-hydroxy-8-nonenoic acid, and 3-hydroxy-6-heptenoic acid, and 63 mol % of 3-hydroxy-4-cyclohexylbutyric acid and others (straight chain 3-hydroxyalkanoic acid having 4 to 12 carbon atoms, and 3-hydroxyalka-5-enoic acid having 10 or 12 carbon atoms).

<Synthesis of Aliphatic Carboxy PHA by Oxidative Reaction (2)>

301 mg of polyhydroxyalkanoate obtained by pre-preparation 2 was added into a 200 mL round bottomed flask, and 20 mL of dichloromethane was further added thereto, so that the above compound was dissolved. The resultant product was left under ice bath cooling, and 3 mL of acetic acid and 541 mg of 18-crown-6-ether were then added thereto, followed by stirring. Thereafter, 430 mg of potassium permanganate was slowly added thereto under ice bath cooling, and the mixture was stirred at room temperature for 20 hours. After completion of the reaction, water (50 mL) and sodium hydrogen sulfite were added to the reaction product. Thereafter, 1.0 mol/L (1.0 N) hydrochloric acid was added thereto, so that the mixed solution was adjusted to pH 1. Dichloromethane contained in the mixed solution was removed on an evaporator, and thereafter, a polymer contained in the solution was recovered. The recovered polymer was washed with 100 mL of methanol and then with 100 mL of pure water three times, and thereafter the polymer was recovered. The recovered polymer was dried under reduced pressure, so as to obtain 184 mg of PHA of interest.

The average molecular weight of the obtained PHA was evaluated in the same manner as in Example 1. As a result, number average molecular weight Mn=111,800, and weight average molecular weight Mw=272,800.

In order to specify the structure of the obtained PHA, an NMR analysis was carried out under the same conditions as in Example 1. As a result, it was confirmed that the obtained PHA was a polyhydroxyalkanoate copolymer, which comprised, as monomer units, 3-hydroxy-4-cyclohexylbutyric acid, 3-hydroxy-9-carboxynonanoic acid, 3-hydroxy-7-carboxyheptanoic acid, and 3-hydroxy-5-carboxyvaleric acid represented by the following chemical formula (31), (28), (29) and (30) respectively.

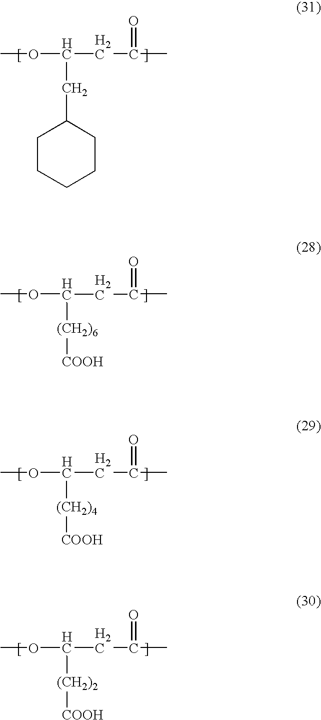

Moreover, in order to calculate the ratio of the units of the obtained PHA, a carboxyl group located at the end of the side chain of PHA was methyl-esterified using trimethylsilyldiazomethane. 30 mg of PHA of interest was added into a 100 mL round bottomed flask, and 2.1 mL of chloroform and 0.4 mL of methanol were then added thereto to dissolve the PHA. 0.9 mL of 0.63 mol/L trimethylsilyldiazomethane-hexane solution (Tokyo Kasei) was added thereto, followed by stirring at room temperature for 30 minutes. After completion of the reaction, the solvent was removed on an evaporator, and thereafter, a polymer contained in the solution was recovered. The recovered polymer was washed with 50 mL of methanol, and then the polymer was recovered. The recovered polymer was dried under reduced pressure, so as to obtain 31 mg of PHA.

An NMR analysis was carried out by the same method as described above. As a result, it was confirmed from the ¹H-NMR spectrum that the ratio of the units was 9 mol % of the total three units, 3-hydroxy-9-carboxynonanoic acid, 3-hydroxy-7-heptanoic acid, and 3-hydroxy-5-valeric acid, and 91 mol % of 3-hydroxy-4-cyclohexylbutyric acid and others (straight chain 3-hydroxyalkanoic acid having 4 to 12 carbon atoms, and 3-hydroxyalka-5-enoic acid having 10 or 12 carbon atoms).

The above method was scaled up, so as to obtain 50 g of PHA, which was denoted as PHA (2).

### Example 3

<Pre-Preparation 3: Biosynthesis of ω-Alkene PHA (3)>

Three shaking flasks (volume: 2000 mL) were prepared. Thereafter, 0.5 wt % polypeptone (Wako Pure Chemical Industries, Ltd.), 4.8 mmol/L 5-phenoxysulfanylvaleric acid, and 2 mmol/L 10-undecenoic acid were dissolved in 1000 mL of the above M9 medium, and the resultant solution was placed in each of the above 2000 mL shaking flasks and sterilized by an autoclave and cooled to room temperature. Pseudomonas cichorii YN2 was shake-cultured for 8 hours in an M9 medium supplemented with 0.5% polypeptone, and 10 mL of the preculture was added to each of the above prepared media, and cultured at 30° C. for 38 hours. After completion of the culture, they were combined, and cells were recovered by centrifugation. The obtained cells were washed with methanol and then dried. After weighing the dried cells, chloroform was added thereto, and the mixture was stirred at 35° C. for 25 hours to extract a polymer. The chloroform containing the extracted polymer was filtrated through a 0.45 μm membrane filter, and the filtrate was concentrated using an evaporator. The condensate was then reprecipitated with cold methanol, to recover a polymer. Thereafter, the obtained polymer was dried under reduced pressure to obtain a polymer of interest.

As a result of weighing the obtained polymer, 1,934 mg of PHA (dry weight) was obtained in the present example.

The average molecular weight of the obtained PHA was evaluated in the same manner as in Example 1. As a result, number average molecular weight Mn=430,000, and weight average molecular weight Mw=1,500,000. Moreover, in order to specify the structure of the obtained PHA, an NMR analysis was carried out under the same conditions as in Example 1.

As a result, it was confirmed that the obtained PHA was a polyhydroxyalkanoate copolymer, which comprised, as monomer units, 3-hydroxy-5-(phenylsulfanyl)valeric acid, 3-hydroxy-10-undecenoic acid, 3-hydroxy-8-nonenoic acid, and 3-hydroxy-6-heptenoic acid represented by the following chemical formulas (32), (25), (26) and (27) respectively.

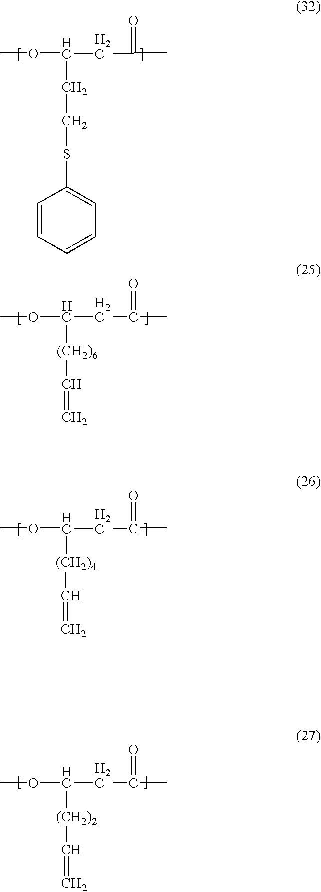

From the ¹H-NMR spectrum, it was confirmed that the proportion of these units was 78 mol % of 3-hydroxy-5-(phenylsulfanyl)valeric acid, 19 mol % of the total three units of 3-hydroxy-10-undecenoic acid, 3-hydroxy-8-nonenoic acid, and 3-hydroxy-6-heptenoic acid, and 3 mol % of others (straight chain 3-hydroxyalkanoic acid having 4 to 12 carbon atoms, and 3-hydroxyalka-5-enoic acid having 10 or 12 carbon atoms).

<Synthesis of Aliphatic Carboxy PHA by Oxidative Reaction (3)>

302 mg of polyhydroxyalkanoate obtained by pre-preparation 3 was added into a 200 mL round bottomed flask, and 20 mL of dichloromethane was further added thereto, so that the above compound was dissolved. The resultant product was left under ice bath cooling, and 3 mL of acetic acid and 1,154 mg of 18-crown-6-ether were then added thereto, followed by stirring. Thereafter, 917 mg of potassium permanganate was slowly added thereto under ice bath cooling, and the mixture was stirred at room temperature for 19 hours. After completion of the reaction, water (50 mL) and 3,010 mg of sodium hydrogen sulfite were added to the reaction product. Thereafter, 1.0 N hydrochloric acid was added thereto, so that the mixed solution was adjusted to pH 1. Dichloromethane contained in the mixed solution was removed on an evaporator, and thereafter, a polymer contained in the solution was recovered. The recovered polymer was washed with 100 mL of methanol and then with 100 mL of pure water three times, and thereafter the polymer was recovered. The recovered polymer was dried under reduced pressure, so as to obtain 311 mg of PHA of interest.

The average molecular weight of the obtained PHA was evaluated in the same manner as in Example 1. As a result, number average molecular weight Mn=62,000, and weight average molecular weight Mw=260,000.

In order to specify the structure of the obtained PHA, an NMR analysis was carried out under the same conditions as in Example 1.

As a result, it was confirmed that the obtained PHA was a polyhydroxyalkanoate copolymer comprised of monomer units: 3-hydroxy-5-(phenylsulfonyl)valeric acid, 3-hydroxy-9-carboxynonanoic acid, 3-hydroxy-7-carboxyheptanoic acid, and 3-hydroxy-5-carboxyvaleric acid represented by the following chemical formulas (33), (28), (29) and (30) respectively.

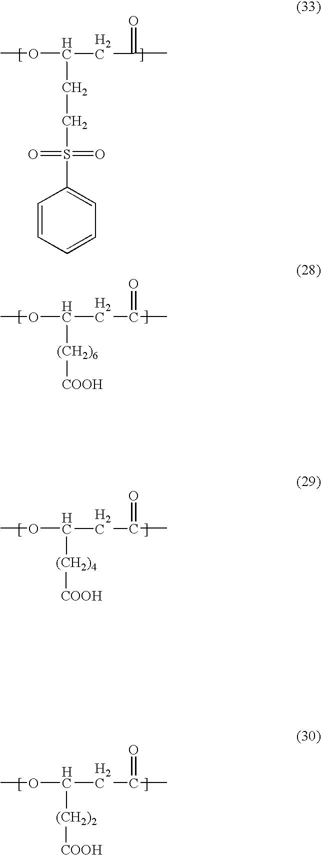

Moreover, in order to calculate the ratio of the units of the obtained PHA, a carboxyl group located at the end of the side chain of PHA was methyl-esterified using trimethylsilyldiazomethane.

30 mg of PHA of interest was added into a 100 mL round bottomed flask, and 2.1 mL of chloroform and 0.7 mL of methanol were then added thereto to dissolve the PHA. 0.5 mL of 2.0 mol/L trimethylsilyldiazomethane-hexane solution (Aldrich) was added thereto, followed by stirring at room temperature for 30 minutes. After completion of the reaction, the solvent was removed on an evaporator, and thereafter, a polymer contained in the solution was recovered. The recovered polymer was washed with 50 mL of methanol, and then the polymer was recovered. The recovered polymer was dried under reduced pressure, so as to obtain 31 mg of PHA.

An NMR analysis was carried out by the same method as described above. As a result, it was confirmed from the ¹H-NMR spectrum that the ratio of the units was 89 mol % of 3-hydroxy-5-(phenylsulfonyl)valeric acid, 8 mol % of the total three units of 3-hydroxy-9-carboxynonanoic acid, 3-hydroxy-7-heptanoic acid, and 3-hydroxy-5-valeric acid, and 3 mol % of others (straight chain 3-hydroxyalkanoic acid having 4 to 12 carbon atoms, and 3-hydroxyalka-5-enoic acid having 10 or 12 carbon atoms).

The above method was scaled up to obtain 50 g of PHA, which was denoted as PHA (3).

### Example 4

<Pre-Preparation 4: Biosynthesis of ω-Alkene PHA (4)>

Three shaking flasks (volume: 2000 mL) were prepared. Thereafter, 0.5 wt % polypeptone (Wako Pure Chemical Industries, Ltd.), 6 mmol/L 5-phenylvaleric acid, and 1.5 mmol/L 10-undecenoic acid were dissolved in 1000 mL of the above M9 medium, and the resultant solution was placed in each of the above 2000 mL shaking flasks and sterilized by an autoclave and cooled to room temperature. Pseudomonas cichorii YN2 was shake-cultured for 8 hours in an M9 medium supplemented with 0.5% polypeptone, and 10 mL of the preculture was added to each of the above prepared media, and cultured at 30° C. for 60 hours. After completion of the culture, they were combined, and cells were recovered by centrifugation. The obtained cells were washed with methanol and then dried. After weighing the dried cells, chloroform was added thereto, and the mixture was stirred at 25° C. for 72 hours to extract a polymer. The chloroform containing the extracted polymer was filtrated through a 0.45 μm membrane filter, and the filtrate was concentrated using an evaporator. The condensate was then reprecipitated with cold methanol, to recover a polymer. Thereafter, the obtained polymer was dried under reduced pressure to obtain a polymer of interest.

As a result of weighing the obtained polymer, 1,533 mg of PHA (dry weight) was obtained in the present example.

The average molecular weight of the obtained PHA was evaluated under the same conditions as in Example 1. As a result, number average molecular weight Mn=72,000, and weight average molecular weight Mw=170,000.

Moreover, in order to specify the structure of the obtained PHA, an NMR analysis was carried out under the same conditions as in Example 1.

As a result, it was confirmed that the obtained PHA was a polyhydroxyalkanoate copolymer comprised of monomer units: 3-hydroxy-5-phenylvaleric acid, 3-hydroxy-10-undecenoic acid, 3-hydroxy-8-nonenoic acid, and 3-hydroxy-6-heptenoic acid represented by the following chemical formula (34), (25), (26) and (27) respectively.

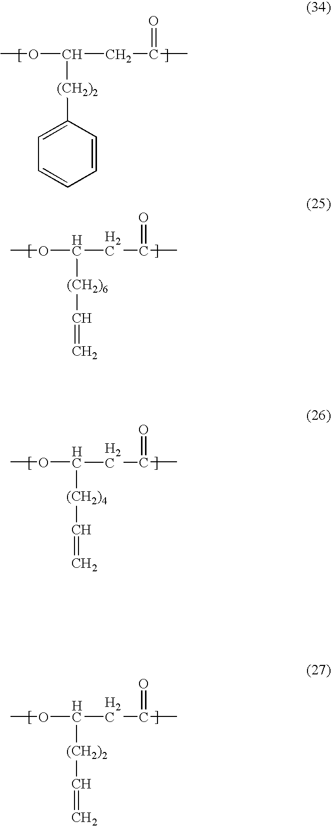

From the ¹H-NMR spectrum, it was confirmed that the proportion of these units was 12 mol % of the total three units, 3-hydroxy-10-undecenoic acid, 3-hydroxy-8-nonenoic acid, and 3-hydroxy-6-heptenoic acid, 85 mol % of 3-hydroxy-5-phenylvaleric acid, and 3 mol % of others (straight chain 3-hydroxyalkanoic acid having 4 to 12 carbon atoms, and 3-hydroxyalka-5-enoic acid having 10 or 12 carbon atoms).

<Synthesis of Aliphatic Carboxy PHA by Oxidative Reaction (4)>

1,002 mg of polyhydroxyalkanoate obtained by pre-preparation 4 was added into a 500 mL round bottomed flask, and 60 mL of acetone was further added thereto, so that the above compound was dissolved. The resultant product was left under ice bath cooling, and 10 mL of acetic acid and 537 mg of 18-crown-6-ether were then added thereto, followed by stirring. Thereafter, 429 mg of potassium permanganate was slowly added thereto under ice bath cooling, and the mixture was stirred under ice bath cooling for 2 hours, followed by further stirring at room temperature for 18 hours. After completion of the reaction, 40 mL of ethyl acetate, 30 mL of water, and 1,000 mg of sodium hydrogen sulfite were added to the reaction product. Thereafter, 1.0 N hydrochloric acid was added thereto, so that the mixed solution was adjusted to pH 1. A-polymer contained in the solution was extracted, and thereafter, the polymer was recovered by solvent removal. The recovered polymer was washed with 200 mL of pure water, then with 200 mL of methanol, and then with 200 mL of pure water three times. Thereafter, it was finally washed with 200 mL of methanol, and the polymer was recovered. The thus recovered polymer was dissolved in 10 mL of tetrahydrofuran, and then using a dialysis membrane (Spectra/Por Standard Regenerated Cellurose Dialysis Membrane 3 from Spectrum), dialysis was carried out over day and night in a 1 L beaker containing 500 mL of methanol. Thereafter, the polymer contained in the dialysis membrane was recovered and then subjected to reduced pressure drying, so as to obtain 953 mg of PHA of interest.

The average molecular weight of the obtained PHA was evaluated under the same conditions as in Example 1. As a result, number average molecular weight Mn=43,000, and weight average molecular weight Mw=94,000.

In order to specify the structure of the obtained PHA, an NMR analysis was carried out under the same conditions as in Example 1.

As a result, it was confirmed that the obtained PHA was a polyhydroxyalkanoate copolymer comprised of monomer units: 3-hydroxy-5-phenylvaleric acid, 3-hydroxy-9-carboxynonanoic acid, 3-hydroxy-7-carboxyheptanoic acid, and 3-hydroxy-5-carboxyvaleric acid represented by the following chemical formulas (34), (28), (29) and (30) repectively.

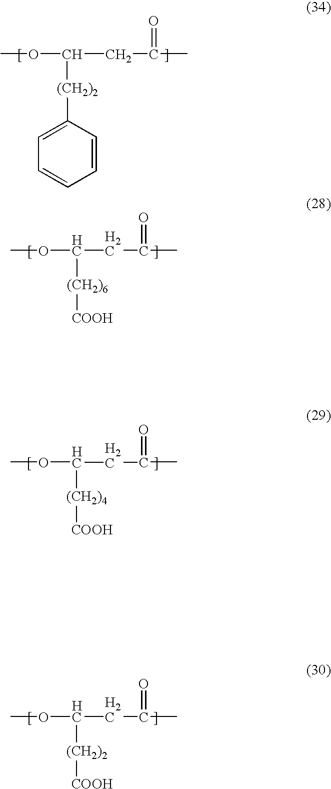

Moreover, in order to calculate the ratio of the units of the obtained PHA, a carboxyl group located at the end of the side chain of PHA was methyl-esterified using trimethylsilyldiazomethane. 30 mg of PHA of interest was added into a 100 mL round bottomed flask, and 2.1 mL of chloroform and 0.7 mL of methanol were then added thereto to dissolve the PHA. 0.3 mL of 2.0 mol %/L trimethylsilyldiazomethane-hexane solution (Aldrich) was added thereto, followed by stirring at room temperature for 30 minutes. After completion of the reaction, the solvent was removed on an evaporator, and thereafter, a polymer contained in the solution was recovered. The recovered polymer was washed with 50 mL of methanol, and then the polymer was recovered. The recovered polymer was dried under reduced pressure, so as to obtain 30 mg of PHA.

An NMR analysis was carried out under the same conditions as in Example 1. As a result, it was confirmed that the ratio of the units was 86 mol % of 3-hydroxy-5-phenylvaleric acid, 9 mol % of the total three units, 3-hydroxy-9-carboxynonanoic acid, 3-hydroxy-7-carboxyheptanoic acid, and 3-hydroxy-5-carboxyvaleric acid, and 5 mol % of others (straight chain 3-hydroxyalkanoic acid having 4 to 12 carbon atoms, and 3-hydroxyalka-5-enoic acid having 10 or 12 carbon atoms).

The above method was scaled up, so as to obtain 50 g of PHA, which was denoted as PHA (4).

### Example 5

<Pre-Preparation 5: Biosynthesis of ω-Alkene PHA (5)>

Twenty shaking flasks (volume: 2000 mL) were prepared. Thereafter, 0.5 wt % polypeptone (Wako Pure Chemical Industries, Ltd.), 6 mmol/L 5-benzoylvaleric acid, and 1 mmol/L 10-undecenoic acid dissolved in 1000 mL of the above M9 medium, and put in each of the above 2000 mL shaking flasks and sterilized by autoclaving and cooled to room temperature. Pseudomonas cichorii YN2 was shake-cultured for 8 hours in an M9 medium supplemented with 0.5% polypeptone, and 10 mL of the preculture was added to each of the above prepared flasks, and cultured at 30° C. for 60 hours. After completion of the culture, they were combined, and cells were recovered by centrifugation. The obtained cells were washed with methanol and then dried. After weighing the dried cells, chloroform was added thereto, and the mixture was stirred at 25° C. for 72 hours to extract a polymer. The chloroform containing the extracted polymer was filtrated through a 0.45 μm membrane filter, and the filtrate was concentrated using an evaporator. The condensate was then reprecipitated with cold methanol, to recover a polymer. Thereafter, the obtained polymer was dried under reduced pressure to obtain a polymer of interest.

As a result of weighing the obtained polymer, 1,027 mg of PHA (dry weight) was obtained in the present example.

The average molecular weight of the obtained PHA was evaluated under the same conditions as in Example 1. As a result, number average molecular weight Mn=120,000, and weight average molecular weight Mw=370,000.

Moreover, in order to specify the structure of the obtained PHA, an NMR analysis was carried out under the same conditions as in Example 1.

As a result, it was confirmed that the obtained PHA was a polyhydroxyalkanoate copolymer comprised of monomer units: 3-hydroxy-5-benzoylvaleric acid, 3-hydroxy-10-undecenoic acid, 3-hydroxy-8-nonenoic acid), and 3-hydroxy-6-heptenoic acid represented by the following chemical formulas (35), (25), (26) and (27) respectively.

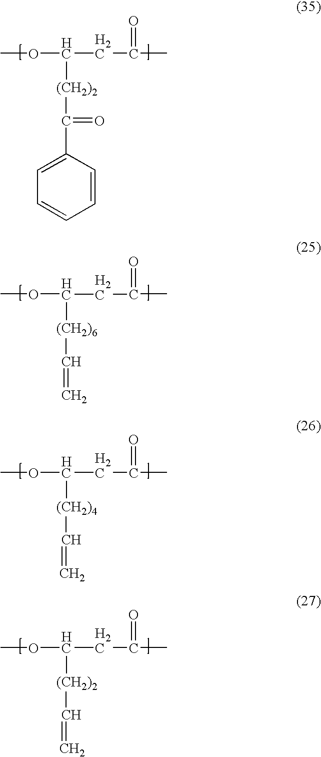

From the ¹H-NMR spectrum, it was confirmed that the proportion of these units was 11 mol % of the total three units, 3-hydroxy-10-undecenoic acid, 3-hydroxy-8-nonenoic acid, and 3-hydroxy-6-heptenoic acid, 82 mol % of 3-hydroxy-5-benzoylvaleric acid, and 7 mol % of others (straight chain 3-hydroxyalkanoic acid having 4 to 12 carbon atoms, and 3-hydroxyalka-5-enoic acid having 10 or 12 carbon atoms).

1,003 mg of polyhydroxyalkanoate obtained by pre-preparation 5 was added into a 500 mL round bottomed flask, and 20 mL of dichloromethane was further added thereto, so that the above compound was dissolved. The resultant product was left under ice bath cooling, and 10 mL of acetic acid and 410 mg of 18-crown-6-ether were then added thereto, followed by stirring. Thereafter, 327 mg of potassium permanganate was slowly added thereto under ice bath cooling, and the mixture was stirred under ice bath cooling for 2 hours, followed by further stirring at room temperature for 18 hours. After completion of the reaction, 100 mL of water, and 1,000 mg of sodium hydrogen sulfite were added to the reaction product. Thereafter, 1.0 N hydrochloric acid was added thereto, so that the mixed solution was adjusted to pH 1. Dichloromethane contained in the mixed solution was removed on an evaporator, and then a polymer contained in the solution was recovered. The recovered polymer was washed with 200 mL of pure water, then with 200 mL of methanol, and then with 200 mL of pure water three times. Thereafter, it was finally washed with 200 mL of methanol, and the polymer was recovered. The thus recovered polymer was dissolved in 10 mL of tetrahydrofuran, and then using a dialysis membrane (Spectra/Por Standard Regenerated Cellurose Dialysis Membrane 3 from Spectrum), dialysis was carried out over day and night in a 1 L beaker containing 500 mL of methanol. Thereafter, the polymer contained in the dialysis membrane was recovered and then subjected to reduced pressure drying, so as to obtain 948 mg of PHA of interest.

The average molecular weight of the obtained PHA was evaluated under the same conditions as in Example 1. As a result, number average molecular weight Mn=76,000, and weight average molecular weight Mw=235,000.

In order to specify the structure of the obtained PHA, an NMR analysis was carried out under the same conditions as in Example 1.

As a result, it was confirmed that the obtained PHA was a polyhydroxyalkanoate copolymer comprised of monomer units: 3-hydroxy-5-benzoylvaleric acid, 3-hydroxy-9-carboxynonanoic acid, 3-hydroxy-7-carboxyheptanoic acid, and 3-hydroxy-5-carboxyvaleric acid represented by the following chemical formulas (35), (28), (29) and (30) respectively.

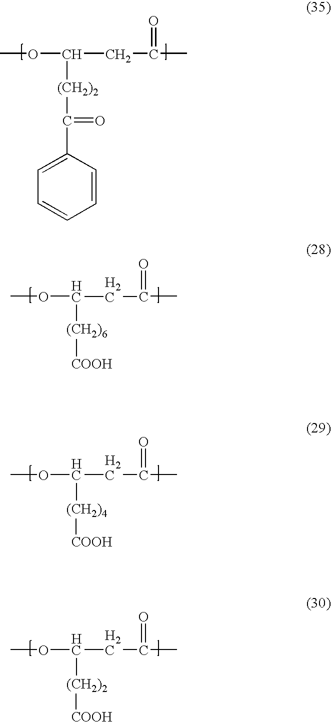

Moreover, in order to calculate the ratio of the units of the obtained PHA, a carboxyl group located at the end of the side chain of PHA was methyl-esterified using trimethylsilyldiazomethane.

30 mg of PHA of interest was added into a 100 mL round bottomed flask, and 2.1 mL of chloroform and 0.7 mL of methanol were then added thereto to dissolve the PHA. 0.3 mL of 2.0 mol %/L trimethylsilyldiazomethane-hexane solution (Aldrich) was added thereto, followed by stirring at room temperature for 30 minutes. After completion of the reaction, the solvent was removed on an evaporator, and thereafter, a polymer contained in the solution was recovered. The recovered polymer was washed with 50 mL of methanol, and then the polymer was recovered. The recovered polymer was dried under reduced pressure, so as to obtain 29 mg of PHA.

An NMR analysis was carried out under the same conditions as in Example 1. As a result, it was confirmed that the ratio of the units was 84 mol % of 3-hydroxy-5-benzoylvaleric acid, 9 mol % of the total three units, 3-hydroxy-9-carboxynonanoic acid, 3-hydroxy-7-carboxyheptanoic acid, and 3-hydroxy-5-carboxyvaleric acid, and 7 mol % of others (straight chain 3-hydroxyalkanoic acid having 4 to 12 carbon atoms, and 3-hydroxyalka-5-enoic acid having 10 or 12 carbon atoms).

The above method was scaled up, so as to obtain 50 g of PHA, which was denoted as PHA (5).

### Example 6

5.0 g of polypeptone (Wako Pure Chemical Industries, Ltd.) was added to 1,000 mL of the above M9 medium, and 5-phenylvaleric acid and sebacic acid monomethyl ester were also added thereto to final concentrations of 4 mmol/L and 1 mmol/L, respectively. The mixture was placed in a 2,000 mL shaking flask, sterilized by autoclaving and cooled to room temperature. Pseudomonas cichorii YN2 was shake-cultured for 8 hours in an M9 medium supplemented with 0.5% polypeptone, and 5 mL of the preculture was added to each of the above prepared flasks, and cultured at 30° C. for 40 hours. After completion of the culture, they were combined, and cells were recovered by centrifugation. The obtained cells were washed with methanol and then dried. After weighing the dried cells, chloroform was added thereto, and the mixture was stirred at 50° C. for 48 hours to extract a polymer. The chloroform containing the extracted polymer was filtrated, and the filtrate was concentrated using an evaporator. The condensate was then reprecipitated with cold methanol, to recover a polymer. Thereafter, the obtained polymer was dried under reduced pressure to obtain a polymer of interest. As a result of weighing the obtained polymer, 671 mg of PHA (dry weight) was obtained in the present example.

The structure of the obtained polymer was determined by the following methylation-GC/MS method. That is to say, 5 mg of polymer was dissolved in 2 mL of chloroform, 2 mL of methanol-3% sulfuric acid solution was further added thereto, and a reaction was carried out under reflux at 100° C. for 3.5 hours. After completion of the reaction, the reaction solution was cooled to room temperature, and 10 mL of deionized water was added thereto followed by stirring and separation. The organic layer was dehydrated with magnesium sulfate (anhydride), and thereafter, the reaction solution was subjected to measurement with a gas chromatograph-mass spectrometer (GC/MS: Shimadzu QP-5050A, column: DB-WAXETR 0.32 mm×30 m). Three main peaks were observed at 35.6 minutes, 38.0 minutes, and 45.8 minutes. As a result of measuring the mass spectrum (MS) of each peak, it was found that the peak at 35.6 minutes was derived from the unit represented by chemical formula (36): 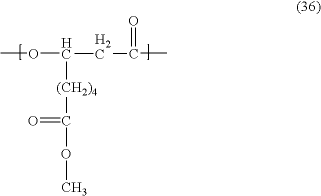
that the peak at 38.0 minutes was derived from the unit represented by chemical formula (34): 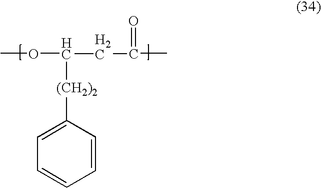
and that the peak at 45.8 minutes was derived from the unit represented by chemical formula (37): 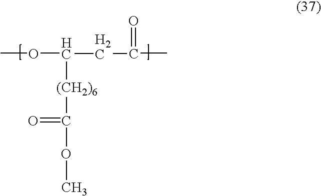
Moreover, the ratio of the units calculated from the peak area ratio of TIC was 12.0%, 77.7%, and 6.7%, respectively.

The average molecular weight of the obtained PHA was evaluated under the same conditions as in Example 1. As a result, number average molecular weight Mn=81,000, and weight average molecular weight Mw=159,000.

The above method was scaled up, so as to obtain 50 g of PHA, which was denoted as PHA (6).

### Example 7

Two shaking flasks (volume: 2,000 mL) were prepared. Thereafter, 0.5 wt % polypeptone (Wako Pure Chemical Industries, Ltd.), 4 mmol/L 5-phenoxyvaleric acid, and 1 mmol/L dodecanedioic acid monoethyl ester were dissolved in 1,000 mL of the above M9 medium, and the resultant solution was placed in each of the above 2,000 mL shaking flasks, sterilized by autoclaving, and cooled to room temperature. 5 mL of the culture solution of Pseudomonas cichorii YN2 strain that had previously been subjected to shaking culture at 30° C. for 8 hours in an M9 medium containing 0.5% polypeptone was added to each of the above prepared media, cultured at 30° C. for 41 hours. After completion of the culture, cells were recovered by centrifugation, and the obtained cells were washed with methanol and then lyophilized. After weighing the dried cells, chloroform was added thereto, and the mixture was stirred at 50° C. for 48 hours to extract polymer. The chloroform containing the extracted polymer was filtrated, and the filtrate was concentrated using an evaporator. The precipitated and solidified portion was collected with cold methanol, and dried under reduced pressure, so as to obtain a polymer of interest. As a result of weighing the obtained polymer, 680 mg of PHA (dry weight) was obtained in the present example.

The average molecular weight of the obtained PHA was evaluated under the same conditions as in Example 1. As a result, number average molecular weight Mn=69,000, and weight average molecular weight Mw=135,000.

Moreover, in order to specify the structure of the obtained PHA, an NMR analysis was carried out under the same conditions as in Example 1.

As a result, it was confirmed that the obtained PHA was a polyhydroxyalkanoate copolymer, which comprised 74 mol % of 3-hydroxy-5-phenoxyvaleric acid, 17 mol % of the total three units, 3-hydroxy-11-ethoxycarbonyl undecanoic acid, 3-hydroxy-9-ethoxycarbonyl nonanoic acid, and 3-hydroxy-7-ethoxycarbonyl heptanoic acid represented by the following chemical formulas (24), (38), (39) and (40) respectively, and 9 mol % of others (straight chain 3-hydroxyalkanoic acid having 4 to 12 carbon atoms, and 3-hydroxyalka-5-enoic acid having 10 or 12 carbon 10 atoms).

The above method was scaled up, so as to obtain 50 g of PHA, which was denoted as PHA (7).

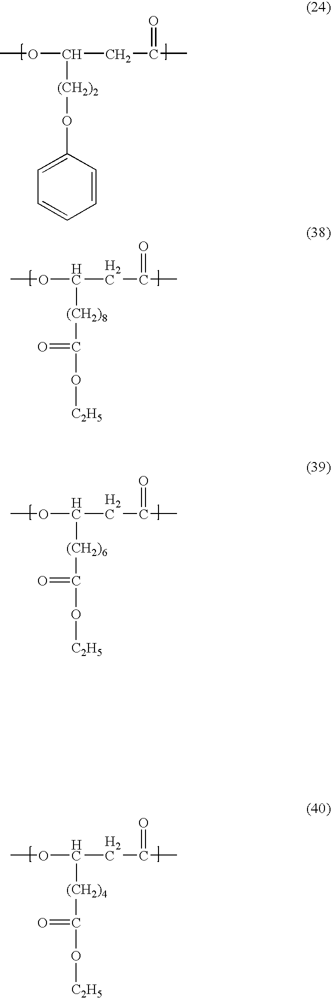

Compounds obtained in Examples 1 to 7 were defined as Example compounds 1 to 7, and the compounds were used in Example 8 and later examples.

Then, charge controlling agents produced in the same manner as in Examples 1 to 7 by methods selected from those of the present invention were used to produce various kinds of toners, and the toners were evaluated.

### Example 8

First, an aqueous Na₃PO₄ solution was added in a 2 liter four-necked flask equipped with a high-speed stirring apparatus TK-Homomixer, and was heated at 60° C., keeping rotation speed at 10,000 rpm. An aqueous CaCl₂ solution was slowly added therein to prepare a water based dispersing medium containing a very small low-water solubility dispersant Ca₃(PO₄)₂.

On the other hand, the following compositions were dispersed for 3 hours using a ball mill, followed by adding therein 10 parts by mass of release agent (ester wax) and 10 parts by mass of 2,2′-azobis(2,4-dimethylvaleronitrile) as a polymerization initiator to prepare a polymerizable monomer composition.

| | | |
|---|---|---|
| styrene monomer | 82 | parts |
| ethylhexyl acrylate monomer | 18 | parts |
| divinylbenzene monomer | 0.1 | parts |
| cyan coloring agent (C.I. Pigment Blue 15) | 6 | parts |
| oxidized polyethylene resin (molecular weight 3200, | 5 | parts |
| acid number 8) | | |
| exemplary compound (1) | 2 | parts. |

Then, the polymerizable monomer composition obtained as described above was put in the above water based dispersant system to form particles at a rotation speed of 10,000 rpm. Thereafter, reaction was carried out at 65° C. for 3 hours stirring with paddle blades, and was thereafter polymerized at 80° C. for 6 hours to complete the polymerization reaction. After the reaction was completed, the suspension was cooled, and an acid was added therein to dissolve the low-water solubility dispersant Ca₃(PO₄)₂, followed by filtering, rinsing and drying the solution to obtain blue polymerized particles (1). The particle size of the obtained blue polymerized particles (1) measured using Coulter Counter Multisizer (from Coulter Co.) was 6.8 μm (weight average particle size), and the ratio of fines (the abundance ratio of particles with the size of 3.17 μm or smaller in the number distribution) was 5.1% by number.

As a fluidity improver, 1.3 parts by mass of hydrophobic silica fine powder (BET: 270 m²/g) treated with hexamethyl disilazane were externally added to 100 parts by mass of blue polymerized particles(1) prepared as described above by dry-mixing using a Henshel mixer, whereby a blue toner (1) of this Example was obtained. In addition, 7 parts by mass of blue toner (1) were mixed with 93 parts by mass resin-coated magnetic ferrite carrier (average particle size: 45 μm) to prepare a two-component type blue developer (1) for magnetic brush development.

### Example 9 to 14

Blue toners (2) to (7) of Examples 9 to 14 were obtained in the same manner as in Example 8 except that 2.0 parts by mass of exemplary compounds (2)-(7) were used in place of the exemplary compound (1). The properties of the toner were measured in the same manner as in Example 8, and the results thereof are shown in Table 1. In addition, two-component type blue developers (2) to (7) were obtained in the same manner as in Example 8 using this toner.

### Comparative Example 1

A blue toner (8) of Comparative Example 1 was obtained in the same manner as in Example 8 except that no exemplary compound was used. The properties of this toner were measured in the same manner as in Example 8, and the results thereof are shown in Table 1. In addition, a two-component type blue developer (8) of Comparative Example 1 was obtained in the same manner as in Example 8 using this toner.

<Evaluation>

For the two-component type blue developers (1) to (7) obtained in the Examples 6 to 14 and the two-component type blue developer (8) obtained in the Comparative Example 1, the charge levels of toners after stirring for 10 and 300 seconds were measured under conditions of normal temperature and normal humidity (25° C., 60% RH) and high temperature and high humidity (30° C., 80% RH) using the previously described method of measuring charge levels. Then, numbers from measurement values of two-component blow-off charge levels were rounded off to the first decimal place to make evaluations according to the following criteria. The results are shown together in Table 1.

[Electrifiability]

AA: Excellent (−20 μC/g or lower)

A: Good (−19.9 to −10.0 μC/g)

B: Usable (−9.9 to −5.0 μC/g)

C: Unusable (−4.9 μC/g or higher)

### Examples 15 to 19

Yellow toners (1) to (7) of Examples 15 to 19 were obtained in the same manner as in Example 8 except that 2.0 parts by mass of exemplary compounds (1) to (7) were used, and a yellow coloring agent (Hansa yellow G) was used in place of the cyan coloring agent. The properties of these toners were measured in the same manner as in Example 8, and the results thereof are shown together in Table 1. In addition, two-component type yellow developers (1) to (7) were obtained in the same manner as in Example 8 using these toners.

### Comparative Example 2

A yellow toner (8) of Comparative Example 2 was obtained in the same manner as in Example 8 except that no charge controlling agent was used, and that the yellow coloring agent (Hansa yellow G) was used in place of the cyan coloring agent. The properties of this toner were measured in the same manner as in Example 8, and the results thereof are shown together in Table 1. In addition, a two-component type yellow developer (8) of Comparative Example 2 was obtained in the same manner as in Example 8 using this toner.

<Evaluation>

For the two-component type yellow developers (1) to (7) obtained in the Examples 15 to 21 and the two-component type yellow developer (8) obtained in the Comparative Example 2, the charge levels of toners after stirring for 10 and 300 seconds were measured under conditions of normal temperature and normal humidity (25° C., 60% RH) and high temperature and high humidity (30° C., 80% RH) using the previously described method of measuring charge levels. Then, numbers from measurement values of two-component blow-off charge levels were rounded off to the first decimal place to make evaluations according to the same criteria as in the Examples 8 to 14. The results are shown together in Table 1.

### Examples 22 to 28

Black toners (1) to (7) of Examples 22 to 28 were obtained in the same manner as in Example 8 except that 2.0 parts by mass of exemplary compounds (1) to (7) were used, and a carbon black (DBP oil absorption 110 mL/100 g) was used in place of the cyan coloring agent. The properties of these toners were measured in the same manner as in Example 8, and the results thereof are shown together in Table 1. In addition, two-component type black developers (1) to (7) were obtained in the same manner as in Example 8 using these toners.

### Comparative Example 3

A black toner (8) of Comparative Example 3 was obtained in the same manner as in Example 8 except that no exemplary compound was used, and that the carbon black (DBP oil absorption 110 mL/100 g) was used in place of the cyan coloring agent. The properties of this toner were measured in the same manner as in Example 8, and the results thereof are shown together in Table 1. In addition, a two-component type black developer (8) of Comparative Example 3 was obtained in the same manner as in Example 8 using this toner.

<Evaluation>

For the two-component type black developers (1) to (7) obtained in the Examples 22 to 28 and the two-component type black developer (8) obtained in the Comparative Example 3, the charge levels of toners after stirring for 10 and 300 seconds were measured under conditions of normal temperature and normal humidity (25° C., 60% RH) and high temperature and high humidity (30° C., 80% RH) using the previously described method of measuring charge levels. Then, numbers from measurement values of two-component blow-off charge levels were rounded off to the first decimal place to make evaluations according to the same criteria as in Examples 8 to 14. The results are shown together in Table 1.

TABLE 1
Particle size distribution and electrification characteristic of toners of various colors

| | | | Particle size | | Electrifiability | | | |
|---|---|---|---|---|---|---|---|---|
| | | | distribution | | Normal temperature | | High temperature | |
| | | | Weight | | and normal | | and high humidity | |
| | | | average | Ratio of | humidity (Q/M) | | (Q/M) | |
| | | | particle | fines | Stirring | Stirring | Stirring | Stirring |
| | Compound | Toner | size | (% by | for 10 | for 300 | for 10 | for 300 |
| Examples | number | Number: | (μm) | number) | seconds | seconds | seconds | seconds |
| 8 | 1 | Blue 1 | 6.8 | 5.1 | AA | AA | AA | AA |
| 9 | 2 | Blue 2 | 6.9 | 5.4 | AA | AA | AA | AA |
| 10 | 3 | Blue 3 | 6.8 | 5.2 | AA | AA | AA | AA |
| 11 | 4 | Blue 4 | 7.0 | 5.0 | AA | AA | AA | AA |
| 12 | 5 | Blue 5 | 6.8 | 4.8 | AA | AA | AA | AA |
| 13 | 6 | Blue 6 | 6.7 | 4.7 | AA | AA | AA | AA |
| 14 | 7 | Blue 7 | 6.9 | 5.0 | AA | AA | AA | AA |
| 15 | 1 | Yellow 1 | 7.0 | 5.6 | AA | AA | AA | AA |
| 16 | 2 | Yellow 2 | 6.9 | 5.4 | AA | AA | AA | AA |
| 17 | 3 | Yellow 3 | 6.8 | 5.5 | AA | AA | AA | AA |
| 18 | 4 | Yellow 4 | 6.8 | 5.4 | AA | AA | AA | AA |
| 19 | 5 | Yellow 5 | 7.1 | 5.7 | AA | AA | AA | AA |
| 20 | 6 | Yellow 6 | 6.9 | 4.9 | AA | AA | AA | AA |
| 21 | 7 | Yellow 7 | 7.0 | 5.2 | AA | AA | AA | AA |
| 22 | 1 | Black 1 | 7.1 | 5.5 | AA | AA | AA | AA |
| 23 | 2 | Black 2 | 7.0 | 5.5 | AA | AA | AA | AA |
| 24 | 3 | Black 3 | 6.8 | 5.3 | AA | AA | AA | AA |
| 25 | 4 | Black 4 | 6.9 | 5.5 | AA | AA | AA | AA |
| 26 | 5 | Black 5 | 7.1 | 5.4 | AA | AA | AA | AA |
| 27 | 6 | Black 6 | 6.7 | 4.8 | AA | AA | AA | AA |
| 28 | 7 | Black 7 | 6.8 | 4.9 | AA | AA | AA | AA |
| Comparative | — | Blue 8 | 7.0 | 5.2 | C | C | C | C |
| Example 1 | | | | | | | | |
| Comparative | — | Yellow 8 | 7.2 | 4.9 | C | C | C | C |
| Example 2 | | | | | | | | |
| Comparative | — | Black 8 | 6.9 | 5.3 | C | B | C | B |
| Example 3 | | | | | | | | |

### Example 29

The following composition were mixed, and were melt-kneaded by a twen screw extruder (L/D=30):

| | | |
|---|---|---|
| stylene-butylacrylate copolymer resin | 100 | parts |
| (glass transition temperature 70° C.) | | |
| magenta pigment (C.I. Pigment Red 114 | 5 | parts |
| exemplary compound (1) | 2 | parts. |

The resulting mixture was cooled, roughly ground by a hammer mill, finely ground by a jet mill, and then classified to obtain magenta coloring particles (1) by a grinding method. For the particle size of the magenta coloring particles (1), the weight average particle size was 6.8 μm and the ratio of fines was 5.0% by number.

As a fluidity improver, 1.5 parts by mass of hydrophobic silica fine powder (BET: 250 m²/g) treated with hexamethyl disilazane were dry-mixed with 100 parts by mass of the magenta coloring particles (1) by a Henshel mixer, whereby a magenta toner (1) of this Example was obtained. In addition, 7 parts by mass of the resulting magenta toner (1) were mixed with 93 parts by mass resin-coated magnetic ferrite carrier (average particle size: 45 μm) to prepare a two-component type magenta developer (1) for magnetic brush development.

### Examples 30 to 35

Magenta toners (2) to (7) of Examples 30 to 35 were obtained in the same manner as in Example 29 except that 2.0 parts by mass of exemplary compound (1) was replaced by each of exemplary compounds (2) to (7). The properties of this toner were measured in the same manner as in Example 8, and the results thereof are shown in Table 2. In addition, two-component type magenta developers (2) to (7) were obtained in the same manner as in Example 29 using this toner.

### Comparative Example 4

A magenta toner (16) of Comparative Example 4 was obtained in the same manner as in Example 29 except that no exemplary compound was used. The properties of this toner were measured in the same manner as in Example 8, and the results thereof are shown together in Table 2. In addition, a two-component type magenta developer (16) of Comparative Example 4 was obtained in the same manner as in Example 29 using this toner.

<Evaluation>

For the two-component type magenta developers (9) to (15) obtained in the Examples 29 to 35 and the two-component type magenta developer (16) obtained in the Comparative Example 4, the charge levels of toners after stirring for 10 and 300 seconds were measured under conditions of normal temperature and normal humidity (25° C., 60% RH) and high temperature and high humidity (30° C., 80% RH) using the previously described method of measuring charge levels. Then, numbers from measurement values of two-component blow-off charge levels were rounded off to the first decimal place to make evaluations according to the following criteria. The results are shown together in Table 2.

[Electrifiability]

AA: Excellent (−20 μC/g or lower)

A: Good (−19.9 to −10.0 μC/g)

B: Usable (−9.9 to −5.0 μC/g)

C: Unusable (−4.9 μC/g or higher)

### Examples 36 to 42

Black toners (9) to (15) of Examples 36 to 42 were obtained in the same manner as in Example 29 except that 2.0 parts by mass of exemplary compounds (1) to (7) were used, and a carbon black (DBP oil absorption 110 mL/100 g) was used in place of the magenta pigment. The properties of these toners were measured in the same manner as in Example 8, and the results thereof are shown together in Table 2. In addition, two-component type black developers (9) to (15) were obtained in the same manner as in Example 29 using these toners.

### Comparative Example 5

A black toner (16) of Comparative Example 5 was obtained in the same manner as in Example 29 except that no exemplary compound was used, and that the carbon black (DBP oil absorption 110 mL/100 g) was used in place of the magenta pigment. The properties of this toner were measured in the same manner as in Example 8, and the results thereof are shown together in Table 2. In addition, a two-component type black developer (16) of Comparative Example 5 was obtained in the same manner as in Example 29 using this toner.

<Evaluation>

For the two-component type black developers (9) to (15) obtained in the Examples 36 to 42 and the two-component type black developer (16) obtained in the Comparative Example 5, the charge levels of toners after stirring for 10 and 300 seconds were measured under conditions of normal temperature and normal humidity (25° C., 60% RH) and high temperature and high humidity (30° C., 80% RH) using the previously described method of measuring charge levels. Then, numbers from measurement values of two-component blow-off charge levels were rounded off to the first decimal place to make evaluations according to the same criteria as in Examples 29 to 35. The results are shown together in Table 2.

TABLE 2
Particle size distribution and electrification characteristic of toners of various colors

| | | | Particle size | | Electrifiability | | | |
|---|---|---|---|---|---|---|---|---|
| | | | distribution | | Normal temperature | | High temperature | |
| | | | Weight | | and normal | | and high humidity | |
| | | | average | Ratio of | humidity (Q/M) | | (Q/M) | |
| | | | particle | fines | Stirring | Stirring | Stirring | Stirring |
| | Compound | Toner | size | (% by | for 10 | for 300 | for 10 | for 300 |
| Examples | number | Number: | (μm) | number) | seconds | seconds | seconds | seconds |
| 29 | 1 | Red 1 | 6.8 | 5.2 | AA | AA | AA | AA |
| 30 | 2 | Red 2 | 7.1 | 5.4 | AA | AA | AA | AA |
| 31 | 3 | Red 3 | 6.7 | 5.3 | AA | AA | AA | AA |
| 32 | 4 | Red 4 | 7.0 | 5.1 | AA | AA | AA | AA |
| 33 | 5 | Red 5 | 7.1 | 5.5 | AA | AA | AA | AA |
| 34 | 6 | Red 6 | 6.7 | 5.1 | AA | AA | AA | AA |
| 35 | 7 | Red 7 | 6.9 | 5.4 | AA | AA | AA | AA |
| 36 | 1 | Black 9 | 7.1 | 5.3 | AA | AA | AA | AA |
| 37 | 2 | Black 10 | 7.0 | 5.3 | AA | AA | AA | AA |
| 38 | 3 | Black 11 | 6.9 | 5.1 | AA | AA | AA | AA |
| 39 | 4 | Black 12 | 7.2 | 5.5 | AA | AA | AA | AA |
| 40 | 5 | Black 13 | 7.1 | 5.5 | AA | AA | AA | AA |
| 41 | 6 | Black 14 | 7.0 | 5.0 | AA | AA | AA | AA |
| 42 | 7 | Black 15 | 6.8 | 4.9 | AA | AA | AA | AA |
| Comparative | — | Red 16 | 7.1 | 5.1 | C | C | C | C |
| Example 4 | | | | | | | | |
| Comparative | — | Black 16 | 7.0 | 5.7 | C | B | C | B |
| Example 5 | | | | | | | | |

### Example 43

The following composition was prepared:

| | | |
|---|---|---|
| polyester resin | 100 | parts |
| carbon black (DBP absorption 110 mL/100 g) | 5 | parts |
| exemplary compound (1) | 2 | parts. |

The polyester resin was synthesized as follows: 751 parts of bisphenol A propylene oxide 2 mol adduct, 104 parts of terephtalic acid and 167 parts of trimellitic anhydride were poly-condensed with two parts of dibutyltin oxide as a catalyst to obtain a polyester resin having a softening point of 125° C.

The above described composition was mixed, and melt-kneaded by a twen screw extruder (L/D=30). The resulting mixture was cooled, was thereafter roughly ground by a hammer mill and finely ground by a jet mill, and was thereafter classified to obtain black coloring particles (17) by a grinding method. For the particle size of the black coloring particles (17), the weight average particle size was 7.6 μm and the ratio of fines was 4.7% by number.

As a fluidity improver, 1.5 parts by mass of hydrophobic silica fine powder (BET: 250 m²/g) treated with hexamethyl disilazane were dry-mixed with 100 parts by mass of the black coloring particles (17) by a Henshel mixer to obtain a black toner (17) of this example. In addition, seven parts by mass of the resulting black toner (17) were mixed with 93 parts by mass of resin-coated magnetic ferrite carrier (average particle size: 44 μm) to prepare a two-component type black developer (17) for magnetic brush development.

### Examples 44 to 49

Black toners (18) to (23) of Examples 44 to 49 were obtained in the same manner as in Example 43 except that 2.0 parts by mass of exemplary compounds (2) to (7) were used in place of exemplary compound (1). The properties of these toners were measured in the same manner as in Example 8, and the results thereof are shown in Table 3. In addition, two-component type black developers (18) to (23) were obtained in the same manner as in Example 43 using this toner.

### Comparative Example 6

A black toner (24) of Comparative Example 6 was obtained in the same manner as in Example 43 except that no exemplary compound was used. The properties of this toner were measured in the same manner as in Example 8, and the results thereof are shown in Table 3. In addition, a two-component type black developer (24) of Comparative Example 6 was obtained in the same manner as in Example 43 using this toner.

<Evaluation>

For the two-component type black developers (17) to (23) obtained in the Examples 43 to 49 and the two-component type black developer (24) obtained in the Comparative Example 6, the charge levels of toners after stirring for 10 and 300 seconds were measured under conditions of normal temperature and normal humidity (25° C., 60% RH) and high temperature and high humidity (30° C., 80% RH) using the previously described method of measuring charge levels. Then, numbers from measurement values of two-component blow-off charge levels were rounded off to the first decimal place to make evaluations according to the following criteria. The results are shown together in Table 3.

[Electrifiability]

AA: Excellent (−20 μC/g or lower)

A: Good (−19.9 to −10.0 μC/g)

B: Usable (−9.9 to −5.0 μC/g)

C: Unusable (−4.9 μC/g or higher)

[Table 3]

TABLE 3
Particle size distribution and electrification characteristic of tonerss of various colors

| | | | Particle size | | Electrifiability | | | |
|---|---|---|---|---|---|---|---|---|
| | | | distribution | | Normal temperature | | High temperature | |
| | | | Weight | | and normal | | and high humidity | |
| | | | average | Ratio of | humidity (Q/M) | | (Q/M) | |
| | | | particle | fines | Stirring | Stirring | Stirring | Stirring |
| | Compound | Toner | size | (% by | for 10 | for 300 | for 10 | for 300 |
| Examples | number | Number: | (μm) | number) | seconds | seconds | seconds | seconds |
| 43 | 1 | Black 17 | 7.6 | 4.7 | AA | AA | AA | AA |
| 44 | 2 | Black 18 | 7.7 | 5.1 | AA | AA | AA | AA |
| 45 | 3 | Black 19 | 7.6 | 4.8 | AA | AA | AA | AA |
| 46 | 4 | Black 20 | 7.5 | 5.2 | AA | AA | AA | AA |
| 47 | 5 | Black 21 | 7.9 | 5.7 | AA | AA | AA | AA |
| 48 | 6 | Black 22 | 7.6 | 5.4 | AA | AA | AA | AA |
| 49 | 7 | Black 23 | 7.8 | 5.8 | AA | AA | AA | AA |
| Comparative | — | Black 24 | 7.5 | 4.9 | C | B | C | B |
| Example 6 | | | | | | | | |

### Examples 50 to 76 and Comparative Examples 7 to 12

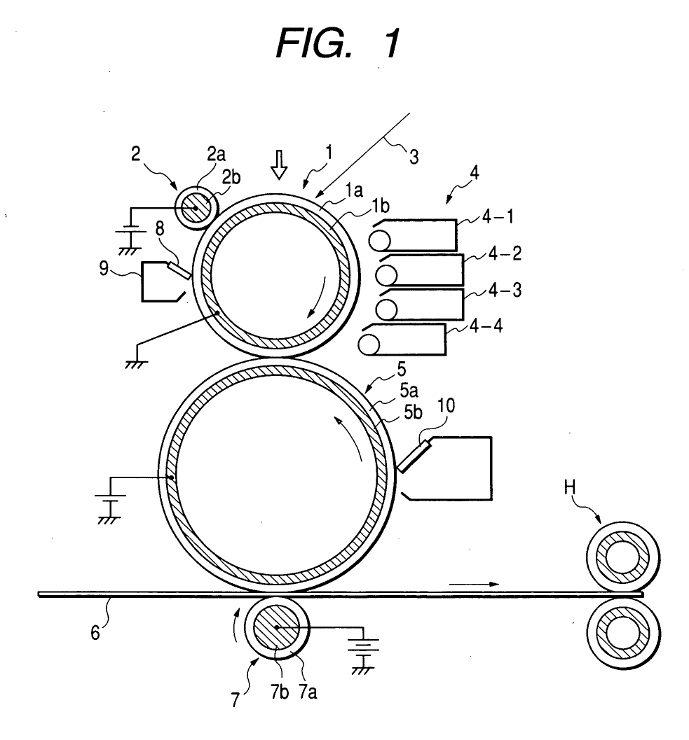

First, an image forming apparatus used in the image formation methods of Examples 50 to 76 and Comparative Examples 7 to 12 will be described. FIG. 1 is a schematic explanatory view of the cross section of an image forming apparatus for carrying out the image formation methods of Examples and Comparative Examples of the present invention. A photosensitive drum 1 shown in FIG. 1 has a photosensitive layer 1a having an organic photo semiconductor on a substrate 1b, and is configured to rotate in the direction indicated by the arrow, and its surface is electrically charged at a potential of about −600 V by a charge roller 2 being a charge member situated opposite to the photosensitive drum 1 and contacting and rotating with the drum. As shown in FIG. 1, the charge roller 2 has a metal core 2b covered with a conductive elastic layer 2a.

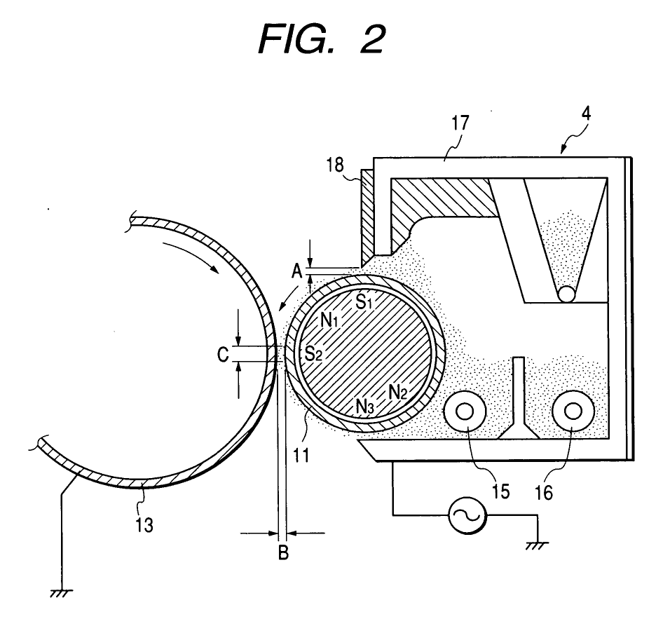

Next, the photosensitive drum 1 with its surface electrically charged is exposed to light 3 and at this time, on/off operations are performed on the photosensitive by a polygon mirror according to digital image information, whereby an electrostatic latent image with the potential of the exposed area being −100 V and the potential of the dark area being −600 V is formed. Subsequently, this electrostatic latent image on the photosensitive drum 1 is reverse-developed and thereby actualized using a plurality of development apparatuses 4-1, 4-2, 4-3 and 4-4, and thus toner imaged are formed on the photosensitive drum 1. At that time, the two-component type developers obtained in the above Examples and Comparative Examples were respectively used as a developer to form a toner image with a yellow toner, a magenta toner, a cyan toner or a black toner. FIG. 2 is an enlarged sectional view of principal parts of development apparatuses 4 for two-component type developers used at that time.

Then, the toner images on the photosensitive drum 1 are transferred to an intermediate transfer member 5 contacting and rotating with the photosensitive drum 1. As a result, a four-color overlapped toner image is formed on the intermediate transfer member 5. A non-transferred toner remaining on the photosensitive drum 1 without being transferred is collected in a residual toner container 9 by a cleaning member 8.

The intermediate transfer member 5 is constituted by a metal core 5b as a support and an elastic layer 5a provided thereon as shown in FIG. 1. In this Example, the intermediate member 5 having the metal core 5b coated with the elastic layer 56 with a carbon black as a conductivity producer sufficiently dispersed in nitrile-butadiene rubber (NBR) was used. The degree of hardness of the elastic layer 56 measured in accordance with “JIS K-6301” was 30 degrees, and the volume resistivity was 10⁹ Ω.cm. The level of transfer current required for transferring the image from the photosensitive drum 1 to the intermediate transfer member 5 is about 5 μA, and this level of current was obtained by adding a voltage of +500 V to the metal core 5b.

The four-color toner-developed image formed on the intermediate transfer member 5 is transferred to a transferring material such as paper by a transfer roller 7, and is thereafter fixed by a heat-fixation apparatus H. The transfer roller 7 is provided thereon the core metal 7b with the outside diameter of 10 mm on which an elastic layer 7a is by coating ethylene-propylene-diene based tridimensional copolymer (EPDM) foam dispersing carbon sufficiently therein as a conductivity producing material. The layer had a volume specific resistance of 10⁶Ω.cm and a hardness degree of 35° as measured in accordance with “JIS K-6301”. In addition, a voltage was applied to this transfer roller 7 to pass a transfer current of 15 μA therethrough.

In the apparatus shown in FIG. 1, a fixation apparatus of heat roll type having no oil coating mechanism shown in FIGS. 1 and 2 was used in the heat-fixation apparatus H. The both upper and lower rollers of the fixation apparatus used here had surface layers made of fluorine based resin. In addition, the diameter of the roller was 60 mm. The fixation temperature for fixation was 160° C., and the nipping width was set at 7 mm. Furthermore, a transfer residual toner on the photosensitive drum 1, which was collected by cleaning and transported to a developing device by a reuse mechanism for reuse.

<Evaluation>

Two-component type developers produced using the toners of Examples 8 to 49 and two-component type developers produced using toners of Comparative Examples 1 to 6 were used, respectively, to perform printout testing at a printout rate of 8 sheets (A4 size) per minute in a monochromatic intermittent mode (namely a mode in which the developing device is stopped for 10 seconds for each printout to accelerate the deterioration of a toner in a preliminary operation during restart of the device), supplying the developer, at a normal temperature and normal humidity (25° C., 60% RH) and a high temperature and high humidity (30° C., 80% RH) under the conditions described above, and resulting printout images were evaluated for the following items. The evaluation results are shown together in Table 4.

[Evaluation of Printout Images]

1. Image Density

Images were printed out on a predetermined number of normal copying papers (75 g/m²), and the image density was evaluated according to the level at which the density of the image from the final printout was retained with respect to the density of the initial image. Here, for the measurement of image density, a Macbeth reflective densitometer (from Macbeth Co., Ltd.) was used to measure a density relative to that of the printout image of a white ground of which original density was 0.00.

AA: Excellent (image density from the final printout is 1.40 or greater)

A: Good (image density from the final printout is 1.35 or greater and lower than 1.40)

B: Usable (image density from the final printout is 1.00 or greater and lower than 1.35)

C: Unusable (image density from the final printout is lower than 1.00)

2. Image Fog

Images were printed out on a predetermined number of normal copying papers (75 g/m²), and the image fog was evaluated with a solid white image of the final printout. Specifically, the evaluation was made as follows: the worst value of the reflective density of the white ground after printing and the average reflective density of the paper before printing, as measured using a reflective densitometer (Reflectometer ODEL TC-6DS from Tokyo Denshoku Co., Ltd.), were defined as Ds and Dr, respectively, and (Ds-Dr) was calculated from these values as a fog level to make an evaluation according to the following criteria.

AA: Excellent (fog level is 0% or higher and lower than 1.5%)

A: Good (fog level is 1.5% or higher and lower than 3.0%)

B: Usable (fog level is 3.0% or higher and lower than 5.0%)

C: Unusable (fog level is higher than 5.0%)

3. Transferability

Solid black images were printed out on a predetermined number of normal copying papers (75 g/m²), and the image dislocation level of the image from the final printout was visually observed to make an evaluation according to the following criterion.

AA: Excellent (almost not observed)

A: Good (slightly observed)

B: Usable

C: Unusable

In addition, in Examples 50 to 76 and Comparative Examples 7 to 12, occurrences of scars and sticking residual toners on the surfaces of the photosensitive drum and the intermediate transfer member, and their influence on printout images (matching with the image forming apparatus) were visually evaluated after 5000 images were outputted, and as a result, scars and sticking residual toners on the surfaces of the photosensitive drum and the intermediate transfer member were not observed at all, and thus matching with the image forming apparatus was excellent. On the other hand, in the system using two-component type developers of Comparative Examples 7 to 12, sticking toners and surface scars were observed on the surface of the intermediate transfer member, and there was a problem in matching with image formation apparatus such that longitudinal striped defects occurred in the image.

TABLE 4

| | Two- | Normal temperature and normal | | | High temperature and high | | |
|---|---|---|---|---|---|---|---|
| | component | humidity | | | humidity | | |
| | type | Image | Image | | Image | Image | |
| Examples | developer | density | fog | Transferability | density | fog | Transferability |
| 50 | Blue 1 | AA | AA | AA | AA | AA | AA |
| 51 | Blue 2 | AA | AA | AA | AA | AA | AA |
| 52 | Blue 3 | AA | AA | AA | AA | AA | AA |
| 53 | Blue 4 | AA | AA | AA | AA | AA | AA |
| 54 | Blue 5 | AA | AA | AA | AA | AA | AA |
| 55 | Blue 6 | AA | AA | AA | AA | AA | AA |
| 56 | Blue 7 | AA | AA | AA | AA | AA | AA |
| 57 | Yellow 1 | AA | AA | AA | AA | AA | AA |
| 58 | Yellow 2 | AA | AA | AA | AA | AA | AA |
| 59 | Black 1 | AA | AA | AA | AA | AA | AA |
| 60 | Black 2 | AA | AA | AA | AA | AA | AA |
| 61 | Black 4 | AA | AA | AA | AA | AA | AA |
| 62 | Black 6 | AA | AA | AA | AA | AA | AA |
| 63 | Red 1 | AA | AA | AA | AA | AA | AA |
| 64 | Red 2 | AA | AA | AA | AA | AA | AA |
| 65 | Red 3 | AA | AA | AA | AA | AA | AA |
| 66 | Red 4 | AA | AA | AA | AA | AA | AA |
| 67 | Red 7 | AA | AA | AA | AA | AA | AA |
| 68 | Black 9 | AA | AA | AA | AA | AA | AA |
| 69 | Black 10 | AA | AA | AA | AA | AA | AA |
| 70 | Black 12 | AA | AA | AA | AA | AA | AA |
| 71 | Black 14 | AA | AA | AA | AA | AA | AA |
| 72 | Black 15 | AA | AA | AA | AA | AA | AA |
| 73 | Black 17 | AA | AA | AA | AA | AA | AA |
| 74 | Black 18 | AA | AA | AA | AA | AA | AA |
| 75 | Black 19 | AA | AA | AA | AA | AA | AA |
| 76 | Black 22 | AA | AA | AA | AA | AA | AA |
| Comparative | Blue 8 | C | C | C | C | C | C |
| Example 7 | | | | | | | |
| Comparative | Yellow 8 | C | C | C | C | C | C |
| Example 8 | | | | | | | |
| Comparative | Black 8 | B | B | C | B | C | C |
| Example 9 | | | | | | | |
| Comparative | Red 8 | B | B | C | B | C | C |
| Example 10 | | | | | | | |
| Comparative | Black 16 | B | B | C | C | C | C |
| Example 11 | | | | | | | |
| Comparative | Black 24 | B | B | C | B | C | C |
| Example 12 | | | | | | | |

### Examples 77 to 91 and Comparative Examples 13 to 15

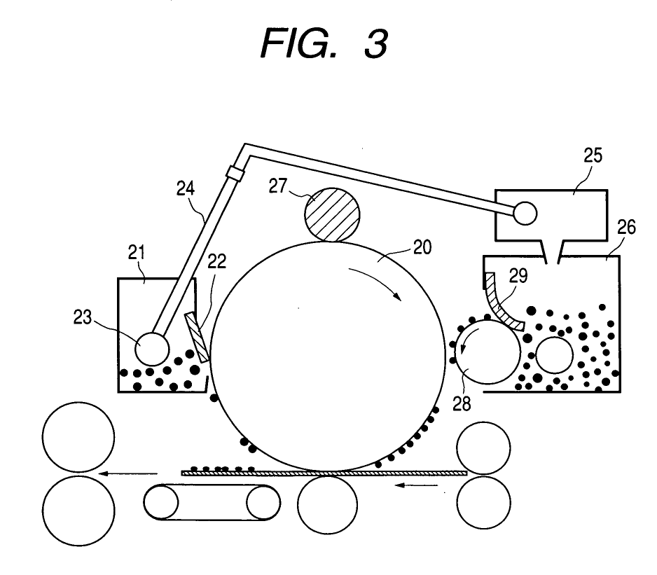

For carrying out the image formation methods of Examples 77 to 91 and Comparative Examples 13 to 15, the toners obtained in Examples 8 to 28 and Comparative examples 1 to 3 were used, respectively, as a one-component developer. In addition, for means for forming an image, an image forming apparatus with a commercially available laser beam printer LBP-EX (from Canon Inc.) modified so that it was provided with a reuse mechanism and reset as shown in FIG. 3 was used. That is, the image forming apparatus shown in FIG. 3 is provided with a system in which a non-transferred toner remaining on the photosensitive drum 20 after the transfer process is scraped off by an elastic blade 22 of a cleaner 21 abutting against the photosensitive drum 20, then sent into the cleaner 21 by a cleaner roller, passed through a cleaner reuse 23, and returned to the development device 26 via a hopper 25 by a supply pipe 24 with a carrier screw mounted therein, and the toner collected in this way is reused.

In the image forming apparatus shown in FIG. 3, the surface of the photosensitive drum 20 is electrically charged by a primary charge roller 27. A rubber roller (diameter 12 mm, abutment pressure 50 g/cm) coated with a nylon resin and having conductive carbon dispersed therein was used for the primary charge roller 27, and an electrostatic latent image with a dark area potential VD of 31 700 V and a light area potential VL of −200 V was formed on the electrostatic latent image carrier (photosensitive drum 20) by laser exposure (600 dpi, not shown). As a toner carrier, a development sleeve 28 having a roughness degree Ra of 1.1 with the surface coated with a resin having a carbon black dispersed therein was used.

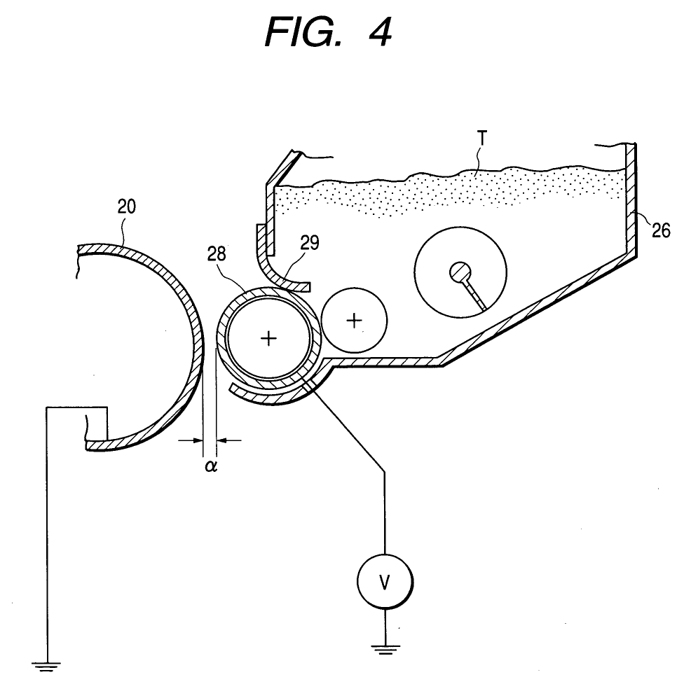

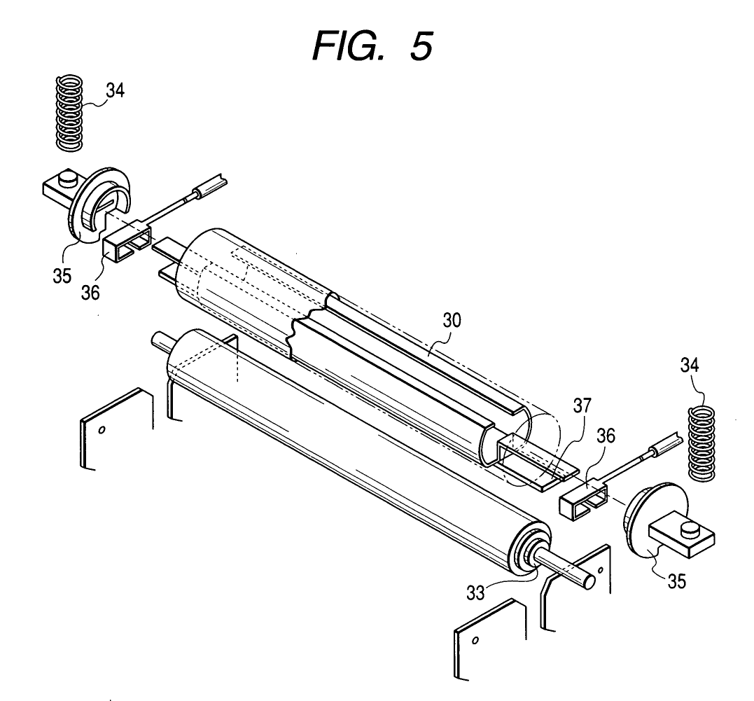

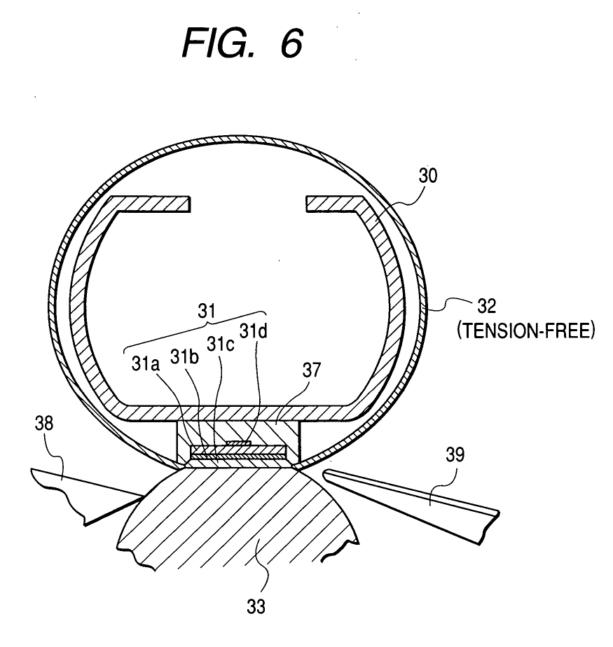

An enlarged sectional view of the principal part of the development apparatus for one-component type developers used in Examples 77 to 91 and Comparative Examples 13 to 15 is shown in FIG. 4. For conditions for developing electrostatic latent images, the speed of the development sleeve 28 was set at a speed 1.1 times as high as the movement speed of the surface of the photosensitive drum 20 opposite thereto, and the space a between the photosensitive drum 20 and the development sleeve 28 (between S and D) was 270 μm. For the member for controlling the thickness of the toner, an abutting urethane rubber blade 29 was used. In addition, the set temperature of the heat-fixation apparatus for fixing a toner image was 160° C. Furthermore, for the fixation apparatus, a fixation apparatus shown in FIGS. 5 and 6 was used.

As described above, under the condition of normal temperature and normal humidity (25° C., 60% RH), images were printed out on up to 30,000 sheets at a printout rate of 8 sheets (A4 size) per minute, in a continuous mode (namely, a mode in which the development device is not stopped, and thereby consumption of the toner is accelerated) supplying the toner, and the densities of resulting printout images were measured to evaluate the durability according to the following criterion. In addition, the image from the 10,000 th printout was observed to make an evaluation about image fog according to the following criterion. At the same time, situations of the components constituting the image forming apparatus after the durability testing were observed to evaluate matching between each component and the above-described toner. The results thereof are shown together in Table 5.

[Change in Image Density During Endurance]

Images were printed out on a predetermined number of normal copying papers (75 g/m²), and the image density was evaluated according to the level at which the density of the image from the final printout was retained with respect to the density of the initial image. Furthermore, for the measurement of image density, a Macbeth reflective densitometer (from Macbeth Co., Ltd.) was used to measure a density relative to that of the printout image of a white ground of which original density was 0.00.

AA: Excellent (image density from the final printout is 1.40 or greater)

A: Good (image density from the final printout is 1.35 or greater and lower than 1.40)

B: Usable (image density from the final printout is 1.00 or greater and lower than 1.35)

C: Unusable (image density from the final printout is lower than 1.00)

[Image Fog]

Images were printed out on a predetermined number of normal copying papers (75 g/m²), and the image fog was evaluated with a solid white image from the final printout. Specifically, the evaluation was made as follow: the worst value of the reflective density of the white ground after printing and the average reflective density of the paper before printing, as measured using a reflective densitometer (Reflectometer ODEL TC-6DS from Tokyo Denshoku Co., Ltd.), were defined as DS and Dr, respectively, (Ds-Dr) was calculated from these values as a fog level to make an evaluation according to the following criterion.

AA: Excellent (fog level is 0% or higher and lower than 1.5%)

A: Good (fog level is 1.5% or higher and lower than 3.0%)

B: Usable (fog level is 3.0% or higher and lower than 5.0%)

C: Unusable (fog level is higher than 5.0%)

[Evaluation of Matching with Image Forming Apparatus]

1. Matching with Development Sleeve

After the printout testing was completed, the situation of residual toners sticking to the surface of the development sleeve and their influence on the printout image were visually evaluated.

AA: Excellent (not observed)

A: Good (almost not observed)

B: Usable (sticking residual toners are observed but the influence on the image is not significant)

C: Unusable (sticking of residual toners is significant, causing unevenness in the image)

2. Matching with Photosensitive Drum

Occurrences of scars and sticking residual toners on the surface of the photosensitive drum and their influence on the printout image were evaluated visually.

AA: Excellent (not observed)

A: Good (slightly observed but no influence on the image)

B: Usable (sticking residual toners and scars are observed but the influence on the image is not significant)

C: Unusable (sticking of residual toners is significant, causing longitudinal striped defects in the image)

3. Matching with Fixation Apparatus

The surface situation of the fixation film was observed, and the results of surface characteristics and occurrences of sticking residual toners were collectively averaged to evaluate the durability of the film.

(1) Surface Characteristics

Occurrences of scares and flaking on the fixation film were visually observed and evaluated after the printout testing was completed.

AA: Excellent (not observed)

A: Good (almost not observed)

B: Usable

C: Unusable

(2) Situation of Sticking Toners

The situation of residual toners sticking to the surface of the fixation film was visually observed and evaluated after the printout testing was completed.

AA: Excellent (not observed)

A: Good (almost not observed)

B: Usable

C: Unusable

TABLE 5

| | | | | | | | Evaluation of matching with other | | | |
|---|---|---|---|---|---|---|---|---|---|---|
| | | Evaluation of printout image | | | | | apparatus | | | |
| | | Change in image density | | | | 10 | | | Fixation | |
| | | during endurance | | | | thousands | | | apparatus | |
| | | | | 10 | 30 | fogged | Development | Photosensitive | Surface | Toner |
| Examples | Toner | Initial | Thousand | thousands | thousands | images | sleeve | drum | characteristic | fixation |
| 77 | Blue 1 | AA | AA | AA | AA | AA | AA | AA | AA | AA |
| 78 | Blue 2 | AA | AA | AA | AA | AA | AA | AA | AA | AA |
| 79 | Blue 4 | AA | AA | AA | AA | AA | AA | AA | AA | AA |
| 80 | Blue 6 | AA | AA | AA | AA | AA | AA | AA | AA | AA |
| 81 | Yellow 1 | AA | AA | AA | AA | AA | AA | AA | AA | AA |
| 82 | Yellow 2 | AA | AA | AA | AA | AA | AA | AA | AA | AA |
| 83 | Yellow 3 | AA | AA | AA | AA | AA | AA | AA | AA | AA |
| 84 | Yellow 4 | AA | AA | AA | AA | AA | AA | AA | AA | AA |
| 85 | Yellow 5 | AA | AA | AA | AA | AA | AA | AA | AA | AA |
| 86 | Yellow 6 | AA | AA | AA | AA | AA | AA | AA | AA | AA |
| 87 | Yellow 7 | AA | AA | AA | AA | AA | AA | AA | AA | AA |
| 88 | Black 1 | AA | AA | AA | AA | AA | AA | AA | AA | AA |
| 89 | Black 2 | AA | AA | AA | AA | AA | AA | AA | AA | AA |
| 90 | Black 5 | AA | AA | AA | AA | AA | AA | AA | AA | AA |
| 91 | Black 6 | AA | AA | AA | AA | AA | AA | AA | AA | AA |
| Comparative | Blue 8 | B | C | C | C | C | C | C | C | C |
| Example 13 | | | | | | | | | | |
| Comparative | Yellow 8 | B | C | C | C | C | C | C | C | C |
| Example 14 | | | | | | | | | | |
| Comparative | Black 8 | A | B | C | C | C | C | C | C | C |
| Example 15 | | | | | | | | | | |

### Example 92

Printout testing was performed with the blue toner (1) of Example 8 in a continuous mode (namely, a mode in which the development device is not stopped, and thereby consumption of the toner is accelerated) supplying the toner, in the same manner as in Example 77 except that the toner reuse mechanism of the image forming apparatus of FIG. 3 was removed, and the printout rate was set at the level of 16 sheets (A4 size) per minute. The resulting printout images and the matching with the image evaluating apparatus used were evaluated for the same items as Examples 77 to 91 and Comparative Examples 13 to 15. As a result, satisfactory results were obtained for all the items.

### Examples 93 to 95

Evaluation was performed in the same manner as in Example 92 except that a blue toner (1) of Example 8 was changed to blue toners (2), (4), and (6) of Examples 9, 11, and 13. As the result, satisfactory results were obtained for all the items.

1. In a charge control agent for controlling a charge of powder or granules, wherein the charge control agent comprises a polyhydroxyalkanoate having at least one kind of 3-hydroxy-ω-carboxyalkanoic acid unit represented by the chemical formula (1): 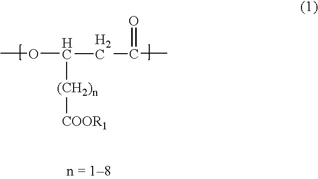
wherein n is an integer selected from the range shown in the same chemical formula; R₁ is an H, Na or K atom, or 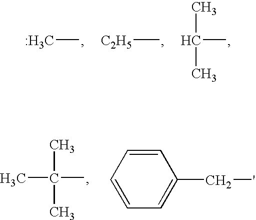
and when more than one unit exists, n and R₁ may differ from unit to unit:

2. The charge control agent according to claim 1, wherein the 3-hydroxy-ω-carboxyalkanoic acid unit represented by the chemical formula (1) includes any one or more selected from the group consisting of:
a 3-hydroxy-11-carboxyundecanoic acid unit represented by the chemical formula (2): 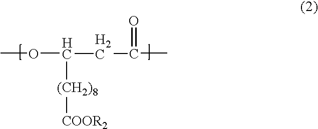
wherein R₂ is an H, Na or K atom, or 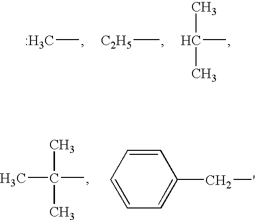
and when more than one unit exists, R₂ may differ from unit to unit,
a 3-hydroxy-9-carboxynonanoic acid unit represented by the chemical formula (3): 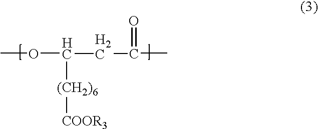
wherein R₃ is an H, Na or K atom, or 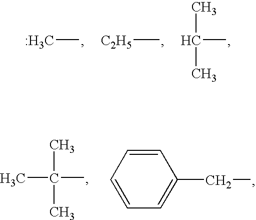
and when more than one unit exists, R₃ may differ from unit to unit,
a 3-hydroxy-7-carboxyheptanoic acid unit represented by the chemical formula (4): 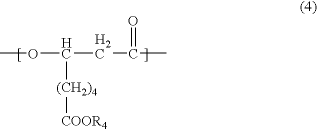
wherein R₄ is an H, Na or K atom, or 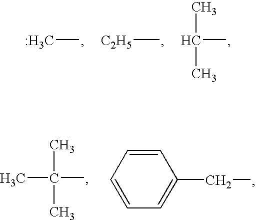
and when more than one unit exists, R₄ may differ from unit to unit,
and
a 3-hydroxy-5-carboxyvaleric acid unit represented by the chemical formula (5): 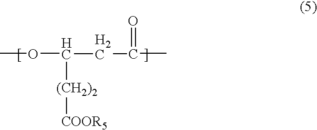
wherein R₅ is an H, Na or K atom, or 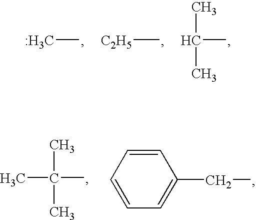
and when more than one unit exists, R₅ may differ from unit to unit.

3. The charge control agent according to claim 1, characterized by comprising a polyhydroxyalkanoate that may have, besides at least one kind of 3-hydroxy-ω-carboxyalkanoic acid represented by the chemical formula (1), a 3-hydroxy-ω-alkanoic acid unit represented by the chemical formula (6): 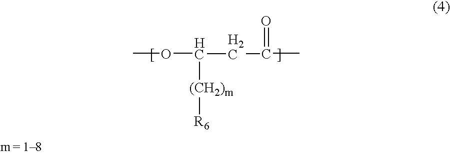
wherein m is an integer selected from the range shown in the same chemical formula; R₆ comprises a residue having either a phenyl structure or a thienyl structure; and when more than one unit exists, m and R₆ may differ from unit to unit,
or
a 3-hydroxy-ω-cyclohexylalkanoic acid unit represented by the chemical formula (7):. 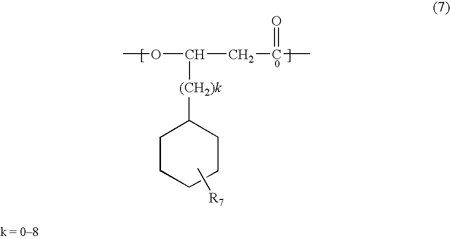
wherein R₇ represents a substitute in the cyclohexyl group and is an H atom, a CN group, an NO₂ group, a halogen atom, a CH₃ group, a C₂H₅ group, a C₃H₇ group, a CF₃ group, C₂F₅ group or a C₃F₇ group; and k is an integer selected from the range shown in the same chemical formula, and when more than one unit exists, R₇ and k may differ from unit to unit.

4. The charge control agent according to claim 1, characterized in that R₆ in the chemical formula (6), namely a residue having either a phenyl or thienyl structure has at least any one chemical formula selected from the group consisting of chemical formulae (8), (9), (10), (11), (12), (13), (14), (15), (16), (17) and (18), and when more than one unit exists, R₆ may differ from unit to unit, wherein
the chemical formula (8) is a group consisting of unsubstituted and substituted phenyl groups represented by: 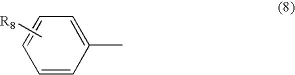
wherein R₈ represents a substituent on the aromatic ring and is an H atom, a halogen atom, a CN group, an NO₂ group, a CH₃ group, a C₂H₅ group, a C₃H₇ group, a CH═CH₂ group, COOR₉ (R₉ represents any one of H, Na and K atoms), a CF₃ group, a C₂F₅ group or a C₃F₇ group, and when more than one unit exists, R₈ may differ from unit to unit,
the chemical formula (9) is a group consisting of unsubstituted and substituted phenoxy groups represented by: 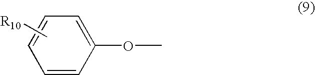
wherein R₁₀ represents a substituent on the aromatic ring and is an H atom, a halogen atom, a CN group, an NO₂ group, a CH₃ group, a C₂H₅ group, a C₃H₇ group, an SCH₃ group, a CF₃ group, a C₂F₅ group or a C₃F₇ group, and when more than one unit exists, R₁₀ may differ from unit to unit,
the chemical formula (10) by a group consisting of unsubstituted and substituted benzoyl groups represented by: 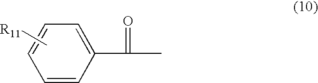
wherein R₁₁ represents a substituent on the aromatic ring and is an H atom, a halogen atom, a CN group, an NO₂ group, a CH₃ group, a C₂H₅ group, a C₃H₇ group, a CF₃ group, a C₂F₅ group or a C₃F₇ group, and when more than one unit exists, R₁₁ may differ from unit to unit, the chemical formula (11) is a group consisting of unsubstituted and substituted phenylsulfanyl groups represented by: 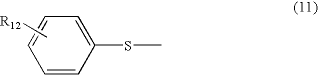
wherein R₁₂ represents a substituent on the aromatic ring and is an H atom, a halogen atom, a CN group, an NO₂ group, a COOR₁₃, an SO₂R₁₄ (R₁₃ represents any one of an H atom, an Na atom, a K atom, a CH₃ group and a C₂H₅ group and R₁₄ represents any one of an OH group, an ONa group, an OK group, a halogen atom, an OCH₃ group and OC₂H₅ group), a CH₃ group, a C₂H₅ group, a C₃H₇ group, a (CH₃)₂—CH group or a (CH₃)₃—C group, and when more than one unit exists, R₁₂ may differ from unit to unit,
the chemical formula (12) is a group consisting of unsubstituted and substituted (phenylmethyl)sulfanyl groups represented by: 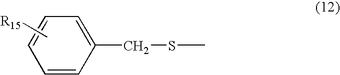
wherein R₁₅ represents a substituent on the aromatic ring and is an H atom, a halogen atom, a CN group, an NO₂ group, a COOR₁₆, an SO₂R₁₇ (R₁₆ represents any one of an H atom, an Na atom, a K atom, a CH₃ group and a C₂H₅ group and R₁₇ represents any one of an OH group, an ONa group, an OK group, a halogen atom, an OCH₃ group and OC₂H₅ group), a CH₃ group, a C₂H₅ group, a C₃H₇ group, a (CH₃)₂—CH group or a (CH₃)₃—C group, and when more than one unit exists, R₁₅ may differ from unit to unit,
the chemical formula (13) is a 2-thienyl group represented by: 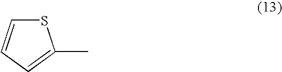
the chemical formula (14) is a 2-thienylsulfanyl group represented by: 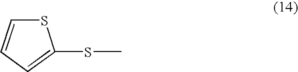
the chemical formula (15) is 2-thienylcarbonyl group represented by: 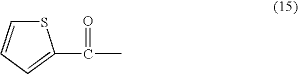
the chemical formula (16) is a group consisting of unsubstituted and substituted phenylsulfinyl groups represented by: 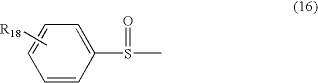
wherein R₁₈ represents a substituent on the aromatic ring and is an H atom, a halogen atom, a CN group, an NO₂ group, a COOR₁₉, an SO₂R₂₀ (R₁g represents any one of an H atom, an Na atom, a K atom, a CH₃ group and a C₂H₅ group and R₂₀ represents any one of an OH group, an ONa group, an OK group, a halogen atom, an OCH₃ group and OC₂H₅ group), a CH₃ group, a C₂H₅ group, a C₃H₇ group, a (CH₃)₂—CH group or a (CH₃)₃—C group, and when more than one unit exists, R₁₈ may differ from unit to unit,
the chemical formula (17) is a group consisting of unsubstituted and substituted phenylsulfonyl groups represented by: 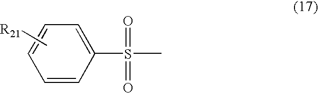
wherein R₂₁ represents a substituent on the aromatic ring and is an H atom, a halogen atom, a CN group, an NO₂ group, a COOR₂₂, an SO₂R₂₃ (R₂₂ represents any one of an H atom, an Na atom, a K atom, a CH₃ group and a C₂H₅ group and R₂₃ represents any one of an OH group, an ONa group, an OK group, a halogen atom, an OCH₃ group and OC₂H₅ group), a CH₃ group, a C₂H₅ group, a C₃H₇ group, a (CH₃)₂—CH group or a (CH₃)₃—C group, and when more than one unit exists, R₂₁ may differ from unit to unit,
the chemical formula (18) is a group of a (phenylmethyl)oxy group represented by:

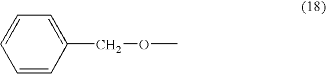

5. The charge control agent according to claim 1, wherein the powder and granular material is a toner for developing electrostatic charge images.

6. The charge control agent according to claim 1, wherein the number average molecular weight of the polyhydroxyalkanoate is in the range of 1,000 to 1,000,000.

7. In a toner binder used for a toner for developing electrostatic charge images, characterized by comprising the charge controlling agent according to any one of claims 1 to 6.

8. A toner for developing electrostatic charge images, characterized by comprising at least a binder resin, a colorant and the charge control agent according to any one of claims 1 to 6.

9. An image forming method, comprising at least a charging step of charging an electrostatic latent image carrier by applying voltage to a charging member from the outside; an electrostatic charge image forming step of forming an electrostatic charge image on the charged electrostatic latent image carrier; a developing step of developing the electrostatic charge image with a toner for developing electrostatic charge images to form a toner image on the electrostatic latent image carrier; a transferring step of transferring the toner image on the electrostatic latent image carrier to a recording medium; and a fixing step of fixing the toner image on the recording medium by heat, characterized in that it uses at least a binder resin, a colorant and the charge control agent according to any one of claims 1 to 6.

10. The image forming method according to claim 9, characterized in that the transferring step comprises a first transferring step of transferring the toner image on the electrostatic latent image carrier to an intermediate transfer medium; and a second transferring step of transferring the toner image on the intermediate transfer medium to a recording medium.

11. An image forming apparatus, comprising at least charging means of charging an electrostatic latent image carrier by applying voltage to a charging member from the outside; electrostatic charge image forming means of forming an electrostatic charge image on the charged electrostatic latent image carrier; developing means of developing the electrostatic charge image with a toner for developing electrostatic charge images to form a toner image on the electrostatic latent image carrier; transferring means of transferring the toner image on the electrostatic latent image carrier to a recording medium; and fixing means of fixing the toner image on the recording medium by heat, characterized in that it uses at least a binder resin, a colorant and the charge control agent according to any one of claims 1 to 6.

12. The image forming apparatus according to claim 11, characterized in that the transferring means comprises first transferring means of transferring the toner image on the electrostatic latent image carrier to an intermediate transfer medium; and second transferring means of transferring the toner image on the intermediate transfer medium to a recording medium.

13. A charge controlling method, characterized by comprising the steps of preparing the charge controlling agent according to any one of claims 1 to 6; and controlling the charged state of a toner using the charge controlling agent.
